(19) United States
(12) Patent Application Publication
(10) Pub. No.: US 2013/0268679 A1
(43) Pub. Date: Oct. 10, 2013

(54) INFORMATION PROCESSING APPARATUS, INFORMATION PROCESSING METHOD, AND PROGRAM

(71) Applicants: Tomoyuki Asano, Kanagawa (JP); Yohei Kawamoto, Tokyo (JP); Seiichi Matsuda, Tokyo (JP)

(72) Inventors: Tomoyuki Asano, Kanagawa (JP); Yohei Kawamoto, Tokyo (JP); Seiichi Matsuda, Tokyo (JP)

(73) Assignee: SONY CORPORATION, Tokyo (JP)

(21) Appl. No.: 13/993,783

(22) PCT Filed: Dec. 8, 2011
(86) PCT No.: PCT/JP2011/078382

§ 371 Date: Jun. 13, 2013

(30) Foreign Application Priority Data
Jan. 28, 2011 (JP) 2011-016439
Oct. 31, 2011 (JP) 2011-238415

(51) Int. Cl. H04L 12/70

(52) U.S. Cl. CPC H04L 47/70
USPC 709/226

(57) ABSTRACT

Provided is an information processing apparatus including a time stamp request unit which requests a time stamp for content data output from a user device from a time stamp allocating unit, and a content data output unit which outputs the content data to which the time stamp is allocated to another user device other than the user device which outputs the content data.

### TECHNICAL FIELD

The present disclosure relates to an information processing apparatus, an information processing method, and a program.

### BACKGROUND ART

In recent years, in accordance with development of equipment such as a digital camera or an Internet environment, a sharing service through which a user generates content data (for example, image data such as a photograph or text data), stores the content data in a server on an Internet and publishes the content data to another users becomes common. Further, many users publish their diary or thoughts to others through a blog.

### CITATION LIST

### Patent Literature

Patent Literature 1: JP H10-508121T

### SUMMARY OF INVENTION

### Technical Problem

In such a situation, there is a behavior such as plagiarism or infringement of a copyright when a third party copies content data which is generated by an arbitrary user and uses the content data in another location as if the content data is generated by the third party.

Further, as a technology that protects various data, a time stamp technology which demonstrates that the data is present at an arbitrary time has been known.

According to the time stamp technology, a user transmits a feature value of data (generally, a result of applying the data to a hash function) to a time stamp authority (TSA) and the TSA returns the feature value of the data and a value obtained by adding a digital signature to a received date as a time stamp.

If an identifier of the user is added to an item which is signed as a time stamp, it is demonstrated that the user holds the content at an arbitrary time. Such a time stamp technology is disclosed, for example, in Patent Literature 1. Patent Literature 1 discloses a technology which collectively allocates a time stamp to a plurality of pieces of data which is stored in a cabinet.

However, the technology disclosed in Patent Literature 1 does not assume that the data is published to other users after storing the data in the cabinet. Further, an owner of data is not demonstrated. Therefore, the technology disclosed in Patent Literature 1 does not contribute to solving the above-mentioned problem.

In the meantime, in order to solve the above-mentioned problem, it is considered to protect the content data using a copy protection technology such as a digital rights management (DRM). However, since the content data uploaded to a server is massive, if the copy protection technology is applied to every content data, a load applied to the server is increased.

Therefore, the present disclosure is made in consideration of the above-mentioned problem and an object of the present disclosure is to provide new and improved information processing apparatus, information processing method, and program which are capable of protecting content data which is published to a third party other than a person who generates the content data.

### Solution to Problem

According to an embodiment of the present disclosure, there is provided an information processing apparatus including a time stamp request unit which requests a time stamp for content data output from a user device from a time stamp allocating unit, and a content data output unit which outputs the content data to which the time stamp is allocated to another user device other than the user device which outputs the content data.

The time stamp request unit may request a time stamp for data in which a plurality of pieces of the content data are aggregated from the time stamp allocating unit.

The time stamp request unit may request, from the time stamp allocating unit, a time stamp for content data output from the user device and identification data indicating a user of the user device which outputs the content data.

The content data output unit may output the content data to which the time stamp is not allocated in addition to the content data to which the time stamp is allocated to a device a user who outputs the content data owns.

When the time stamp is allocated from the time stamp allocating unit after requesting the time stamp from the time stamp allocating unit, the time stamp request unit may request a new time stamp from the time stamp allocating unit.

The time stamp request unit may request the time stamp from the time stamp allocating unit each time the content data is output from the user device.

The content data output unit may further output the time stamp which is allocated to the content data to the other user device.

When the time stamp is requested by the other user device, the content data output unit may output the time stamp which is allocated to the content data to the other user device.

When the user device which outputs the content data requests allocation of the time stamp, the time stamp request unit may request the time stamp from the time stamp allocating unit.

According to another embodiment of the present disclosure, there is provided an information processing method including requesting, from a time stamp allocating unit, a time stamp for content data output from any one of a plurality of user devices, and outputting the content data to another user device other than the user device which outputs the content data, among the plurality of user devices when the time stamp is allocated to the content data.

According to another embodiment of the present disclosure, there is provided a program for causing a computer to implement a time stamp request function of requesting, from a time stamp allocating unit, a time stamp for content data output from any one of a plurality of user devices, and a content data output function of outputting the content data to another user device other than the user data which outputs the content data, among the plurality of user devices when the time stamp is allocated to the content data.

According to another embodiment of the present disclosure, there is provided an information processing system including a plurality of user devices and an information processing apparatus, in which the information processing apparatus includes a time stamp request unit which requests from a time stamp allocating unit a time stamp for content data output from any one of the plurality of user devices; and a content data output unit which outputs the content data to which the time stamp is allocated to another user device than the user device which outputs the content data.

Here, the information processing system may further include a verifying device which verifies whether the time stamp allocated to the content data is correct in accordance with a request from the user of the user device.

Further, the user device may include a verifying unit which verifies whether the time stamp allocated to the content data is correct.

According to another embodiment of the present disclosure, there is provided an information processing apparatus including a content obtaining unit which obtains content data, a content digest data generating unit which generates content digest data, and a communication unit which transmits the content digest data to another information processing apparatus.

According to another embodiment of the present disclosure, there is provided an information processing method including obtaining content data, generating content digest data, and transmitting the content digest data to another information processing apparatus.

According to another embodiment of the present disclosure, there is provided a program for causing a computer to implement a content obtaining function of obtaining content data, a content digest data generating function of generating content digest data, and a communication function of transmitting the content digest data to another information processing apparatus.

According to yet another aspect of the present disclosure, there is provided an information processing system including a first information processing apparatus which receives content data output from a user device, a second information processing apparatus which requests a time stamp for the content data from a time stamp allocating unit, a third information processing apparatus which stores the content data and the time stamp which is allocated to the content data, a fourth information processing apparatus which stores content identification data for identifying the content data, content path data indicating a location of the content data in the third information processing apparatus, and time stamp path data indicating a location of the time stamp in the third information processing apparatus so as to be associated with each other.

### Advantageous Effects of Invention

As described above, according to the present disclosure, even when a user of another user device uses content data without authorization, the date is later than a date indicated by the time stamp so that a user who generates the content data may allege that a person who generates the content data is the user based on the time stamp. That is, content data which is published to a third party other than the user who generates the content data is protected.

### BRIEF DESCRIPTION OF DRAWINGS

FIG. 1 is an explanatory view illustrating an outline of an information processing system according to a first embodiment of the present disclosure.

FIG. 2 is an explanatory view illustrating an outline of a processing by the information processing system according to the first embodiment.

FIG. 3 is a block diagram illustrating a configuration of a content sharing server.

FIG. 4 is a block diagram illustrating a configuration of a data generating unit.

FIG. 5 is an explanatory view illustrating an example of a table which is managed by the content sharing server.

FIG. 6 is an explanatory view illustrating a data structure of content information data.

FIG. 7 is an explanatory view illustrating a data structure of time stamp tag data.

FIG. 8 is an explanatory view illustrating a data structure of content package data.

FIG. 9 is a sequential view illustrating a procedure of a processing by the information processing system.

FIG. 10 is a flowchart illustrating a procedure of a processing by the content sharing server.

FIG. 11 is an explanatory view illustrating an example of an image displayed on a user terminal.

FIG. 12 is a flowchart illustrating a procedure of a processing by the content sharing server.

FIG. 13 is an explanatory view illustrating a correspondence relationship of a type of a contract which a user concludes with a provider and a necessity of obtaining a time stamp.

FIG. 14 is an explanatory view illustrating an outline of an information processing system according to a second embodiment of the present disclosure.

FIG. 15 is a block diagram illustrating a configuration of a user terminal.

FIG. 16 is a block diagram illustrating a configuration of a content generating device.

FIG. 17 is a block diagram illustrating a configuration of a web server.

FIG. 18 is an explanatory view illustrating an example of an unauthorization processing determining table.

FIG. 19 is a block diagram illustrating a configuration of a storage server.

FIG. 20 is a block diagram illustrating a configuration of a database server.

FIG. 21 is an explanatory view illustrating an example of a content information management table.

FIG. 22 is an explanatory view illustrating an example of a time stamp information management table.

FIG. 23 is a block diagram illustrating a configuration of a time stamp obtaining engine.

FIG. 24 is a flowchart illustrating a procedure of a processing by the content generating device.

FIG. 25 is a flowchart illustrating a procedure of a processing by the user terminal.

FIG. 26 is a flowchart illustrating a procedure of a processing by a web server.

FIG. 27 is a flowchart illustrating a procedure of a processing by a web server.

FIG. 28 is a flowchart illustrating a procedure of a processing by a web server.

FIG. 29 is a flowchart illustrating a procedure of a processing by the time stamp obtaining engine.

FIG. 30 is a flowchart illustrating a procedure of a processing by the user terminal.

FIG. 31 is an explanatory view illustrating an example of an image displayed on a display unit of the user terminal.

### DESCRIPTION OF EMBODIMENTS

Hereinafter, preferred embodiments of the present disclosure will be described in detail with reference to the appended drawings. Note that, in this specification and the drawings, elements that have substantially the same function and structure are denoted with the same reference signs, and repeated explanation is omitted.

Further, the explanation will be performed in the following order.

1. First embodiment
1-1. Schematic configuration of information processing system
1-2. Outline of processing by information processing system
1-3. Detailed configuration of information processing system
1-4. Processing by information processing system
1-5. Various modified examples

2. Second embodiment
2-1. Schematic configuration of information processing system
2-2. Detailed configuration of information processing system
2-3. Processing by information processing system

### 1-1. CONFIGURATION OF INFORMATION PROCESSING SYSTEM

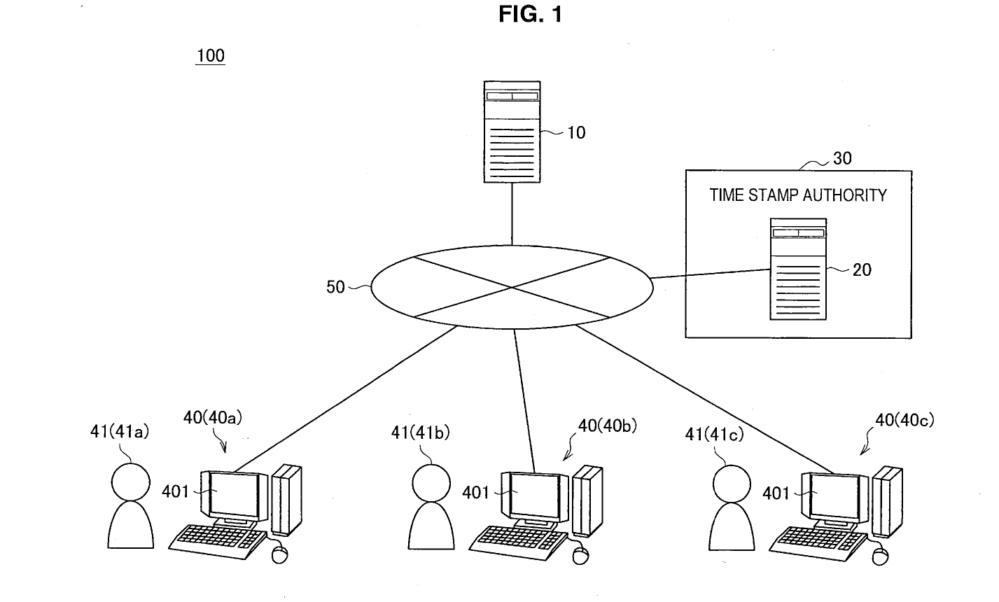

First, a schematic configuration of an information processing system according to a first embodiment will be described with reference to FIG. 1. The information processing system 100 includes a content sharing server (information processing apparatus) 10, a time stamp allocating server (time stamp allocating unit) 20, a plurality of user terminals (user devices) 40, and a network 50 which connects the above units.

The content sharing server 10 is owned by a manager which manages and publishes content data to manage the content data, request a time stamp, and publish content data to which the time stamp is allocated.

The time stamp allocating server 20 is owned by a time stamp authority (TSA) 30 who allocates a time stamp to allocate the time stamp to the content data in accordance with a request from the content sharing server 10.

The user terminals 40 (40a, 40b, and 40c) may be manipulated by different users 41 (41a, 41b, and 41c), respectively and output (upload) content data (UGC (user generated content) data) which is generated by the users 41 to the content sharing server 10. For example, the user 41a uses the user terminal 40a to upload the content data in the content sharing server 10.

Further, the user 41 uses the user terminal 40 to request the content sharing server 10 to browse the content data. The content sharing server 10 outputs the content data, which is requested to be browsed, to the user terminal 40. The user terminal 40 displays the content data received from the content sharing server 10 on a display 401. In addition, as the time stamp allocating server 20 and the user terminal 40, a known time stamp allocating server and a known user terminal are arbitrarily used. For example, the user terminal 40 may be a television receiver, a car navigation, a portable phone, a game machine, a music player, a smart phone, or a smart tablet.

### 1-2. OUTLINE OF PROCESSING BY INFORMATION PROCESSING SYSTEM

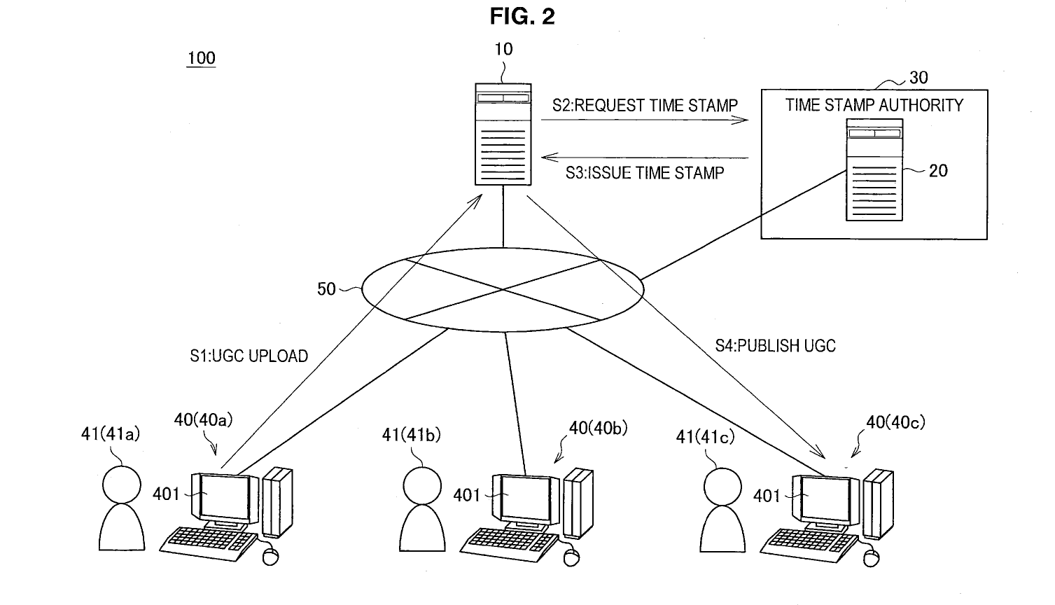

Next, an outline of a processing by the information processing system 100 will be described with reference to FIG. 2. Here, it is assumed that the user 41a uploads the content data and the user 41c browses the content data.

First, in step S1, the user 41a outputs (transmits) the content data which is generated by himself or herself to the content sharing server 10.

In step S2, the content sharing server 10 stores the content data received from the user 41a and requests a time stamp for the content data and data for identifying the user 41a to the time stamp allocating server 20.

In step S3, the time stamp allocating server 20 issues a time stamp for the content data and the data for identifying the user 41a and outputs (transmits) the time stamp to the content sharing server 10.

In step S4, the user 41c requests the content sharing server 10 to browse the content data which is generated by the user 41a. Correspondingly to this, the content sharing server 10 outputs (transmits) content data to which the time stamp is allocated to the user terminal 40c. The user terminal 40c displays the content data on the display 401. By doing this, the content sharing server 10 publish the content data to which the time stamp is allocated to a third party other than the user 41a.

Therefore, even though the user 41c uses the content data (for example, alters the data or publishes the data with his name) without authorization, since the date is later than a data which is indicated by the time stamp, the user 41a may allege that a person who generates the content data is the user 41a based on the time stamp. That is, content data which is published to a third party other than the user 41a is protected. Details of steps S1 to S4 will be described below.

### 1-3. DETAILED CONFIGURATION OF INFORMATION PROCESSING SYSTEM

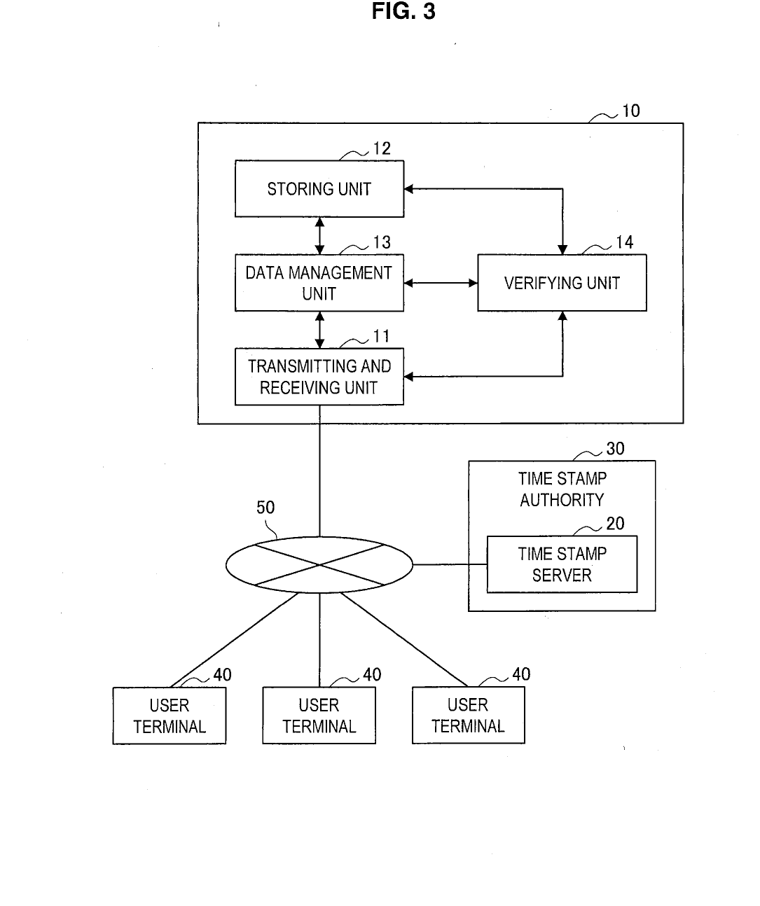

Next, referring to FIGS. 3 to 8, a configuration of the information processing system 100 will be described in detail.

The time stamp allocating server 20 includes various hardware configurations such as a CPU, a ROM, a RAM, a hard disk, and a communication device and performs various processings when the CPU reads out and executes a program stored in the ROM. For example, the time stamp allocating server 20 generates time stamp tag data which will be described below, in accordance with the request of the content sharing server 10, and outputs the time stamp tag data to the content sharing server 10

The user terminal 40 includes various hardware configurations such as a CPU, a ROM, a RAM, a hard disk, a communication device, a keyboard, a mouse, and a display 401 and performs various processings when the CPU reads out and executes a program stored in the ROM. For example, the user terminal 40 outputs an account and a password input by the user 41 to the content sharing server 10 to log in the content sharing server 10, outputs the content data to the content sharing server 10 after logging in the content sharing server 10, and displays the content data output from the content sharing server 10. Here, identification data which uniquely specifies the user 41 who outputs (transmits) the content data on the information processing system 100, for example, an account or a user ID is added to the content data output from the user terminal 40. The account and the user ID may be same numerical values or character strings or the account may be character strings which may be easily memorized or identified by a human and the user ID may be numerical values which correspond to the account one to one.

The content sharing server 10 includes hardware configurations such as a CPU, a ROM, a RAM, a hard disk, and a communication device and performs various processings when the CPU reads out and executes a program stored in the ROM. The content sharing server 10, specifically, includes a transmitting and receiving unit (content data output unit) 11, a storing unit 12, a data management unit 13 (a time stamp requesting unit), and a verifying unit 14.

The transmitting and receiving unit 11 outputs the data received from the time stamp allocating server 20 or the user terminal 40 to the data management unit 13 and outputs the data received from the data management unit 13 to the time stamp allocating server 20 or the user terminal 40.

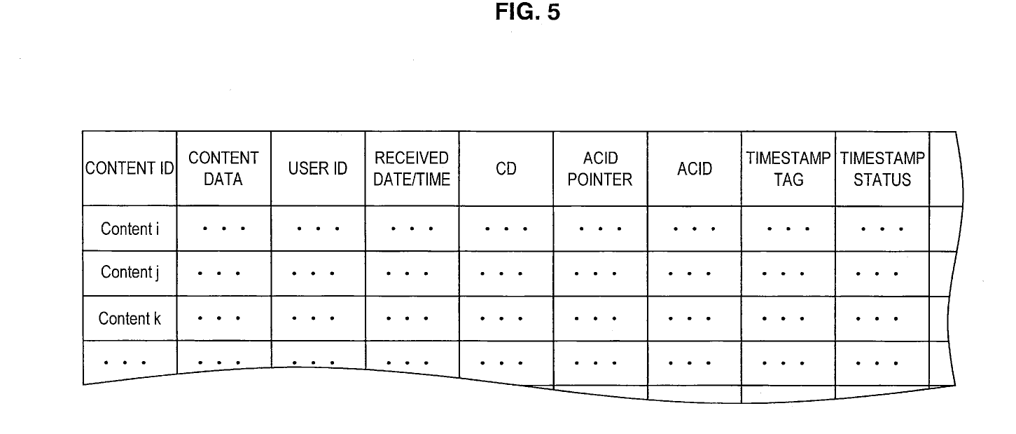

The storing unit 12 stores content data management table illustrated in FIG. 5 and also stores data which is generated by the data management unit 13 or various public keys or public functions (for example, hash functions which will be described below). The content data management table is formed of a plurality of rows and a content ID, content data, a user ID, reception date data, content digest (CD) data, an ACID (agrregated content info digest) pointer, aggregated content information digest data (ACID data), the time stamp tag data, and time stamp status data are recorded in every row so as to correspond to each other. Details of these data will be described below.

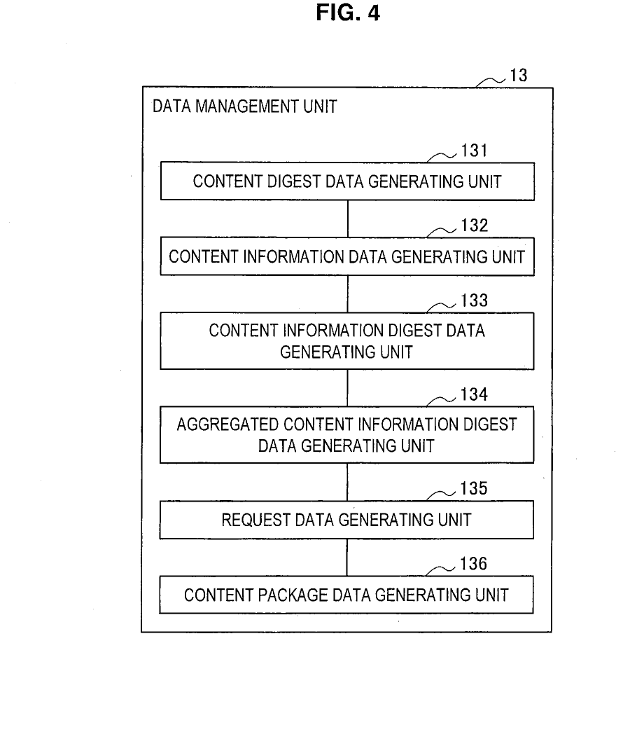

The data management unit 13, as illustrated in FIG. 4, includes a content digest data generating unit 131, a content information data generating unit 132, a content information digest data generating unit 133, an aggregated content information digest data generating unit 134, a request data generating unit 135, and a content package data generating unit 136.

When the content data is received from the transmitting and receiving unit 11, the content digest data generating unit 131 (hereinafter, also referred to as a “CD generating unit 131”) generates a row for content data in the content data management table illustrated in FIG. 5 and stores the content data in the row.

Further, the CD generating unit 131 generates a content ID for uniquely specifying the content data on the information processing system 100 and stores the content ID in a row for the content data together with a user ID for uniquely specifying the user 41 who outputs (transmits) the content data on the information processing system 100. As described above, the user ID is presented by the user during a login processing of a session when the content is transmitted.

Further, the CD generating unit 131 generates the reception date data which indicates a date when the content data is received and stores the reception date data in a row for the content data.

Further, the CD generating unit 131 inputs the content data in the hash function to generate the content digest data (CD data) and stores the content digest data in a row for the content data. In addition, in this application, as the hash function, a hash function which converts the input data into 256 bit data (for example, SHA-2) is used but this application is not limited thereto. The hash function, for example, is arbitrarily selected in accordance with a security level required for the information processing system 100.

Further, the CD generating unit 131 stores an initial value indicating that data is undecided in an area for the ACID pointer, an area for the ACID data, and an area for the time stamp tag data, among respective areas which configure the row for the content data. In addition, the CD generating unit 131 stores an initial value indicating that “a time stamp is not obtained” in an area for the time stamp status data.

The CD generating unit 131 outputs the content ID, the user ID, the reception date data, and the CD data to the content information data generating unit 132.

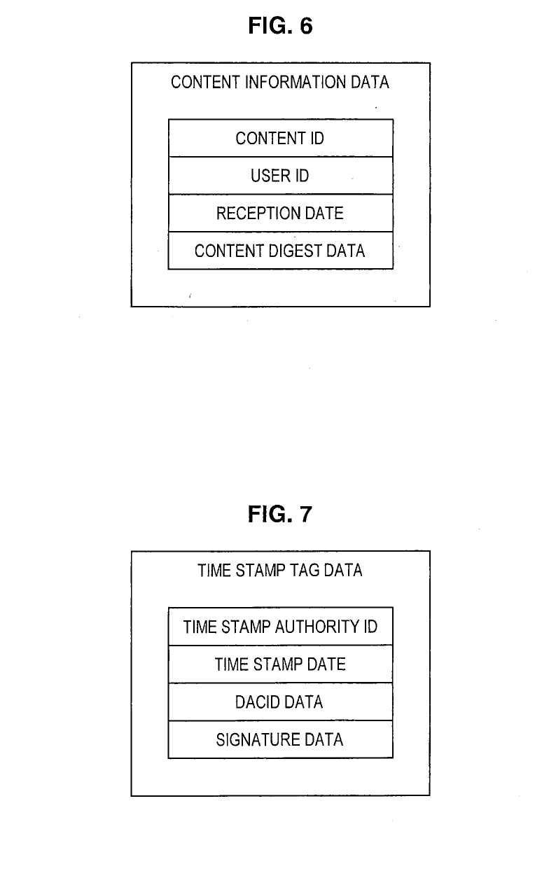

The content information data generating unit 132 (hereinafter, also referred to as “CI (content info) data generating unit 132”) generates content information data (CI data) by as illustrated in FIG. 6, connecting the content ID, the user ID, the reception date data, and the CD data. The CI generating unit 132 outputs the CI data to the content information digest data generating unit 133.

The content information digest data generating unit 133 (hereinafter, also referred to as a CID (content info digest) data generating unit 133) inputs the CI data to the hash function to generate content information digest data (CID data). The CID data generating unit 133 outputs CID data and a content ID corresponding to the CID data (the content ID in the CI data) to the aggregated content information digest data generating unit 134 (hereinafter, also referred to as an “ACID data generating unit 134”).

The ACID data generating unit 134 stands by until the CID data is allocated to all content data which is received by the transmitting and receiving unit 11 within a predetermined time (for example, one minute). The ACID data generating unit 134 connects the CID data which is allocated during the standby to generate ACID data. The ACID generating unit 134 determines a storage target row in which the ACID data is stored based on the content ID included in the CID data which is allocated during the standby. Specifically, the ACID data generating unit 134 determines a row indicated by the content ID as the storage target row. Further, the ACID data generating unit 134 generates an ACID pointer for every storage target row. The ACID pointer is a pointer which indicates where the CID data obtained from the CD data in the storage target row is located in the ACID data. The ACID data generating unit 134 stores the generated ACID data and ACID pointer in the storage target row.

For example, when the transmitting and receiving unit 11 receives contents i and j from the user 41a and content data k from the user 41b and the CID data generating unit 133 generates CID data i′, j′, and k′ within a predetermined time, the ACID data generating unit 134 connects the CID data i′, j′, and k′ to generate ACID data. Further, the ACID data generating unit 134 stores the generated ACID data and the ACID pointer which indicates a location of the CID data i′ in the ACID data in a row in which the content i is stored. As for the contents j and k, the same processing is performed.

Next, the ACID data generating unit 134 outputs the ACID data to the request data generating unit 135.

The request data generating unit 135 inputs the ACID data which is received from the ACID data generating unit 134 in the hash function to generate DACID data (digest ACID data) which is digested ACID data. Here, the hash function converts the data into 256 bit data regardless of the size of the input data so that the request data generating unit 135 maintains the DACID data with a constant size regardless of the size of the ACID data. Therefore, a load applied to management of the DACID data is reduced.

The request data generating unit 135 outputs the time stamp request data which requests the time stamp and the DACID data to the transmitting and receiving unit 11 and changes the time stamp status data of a row in which the ACID data is stored into data indicating “while the time stamp is requested”. The transmitting and receiving unit 11 outputs the time stamp request data and the DACID data to the time stamp allocating server 20. By doing this, the data management unit 13 aggregates one or a plurality of pieces of content data output from the user terminal 40 within the predetermined time and requests the time stamp for the aggregated data from the time stamp allocating server 20.

The time stamp allocating server 20 allocates the time stamp to the DACID data based on the received time stamp request data. Specifically, the time stamp allocating server 20 generates the time stamp tag data illustrated in FIG. 7 and outputs the time stamp tag data to the content sharing server 10. Here, the time stamp tag data is configured by a time stamp authority ID which uniquely specifies the time stamp authority 30 on the information processing system 100, time stamp date data indicating a date (date when the time stamp tag data is generated) when the time stamp is allocated, the DACID data, and signature data by the time stamp authority 30. By doing this, the time stamp allocating server 20 collectively allocates the time stamp to one or a plurality of pieces of content data. The transmitting and receiving unit 11 outputs the received time stamp tag data to the request data generating unit 135.

The request data generating unit 135 stores the time stamp tag data in the row in which the ACID data is stored. Further, the request data generating unit 135 changes the time stamp status data of the row in which the time stamp tag data is stored into data indicating that “the time stamp is completely obtained”.

When there is a request to browse the content data, the content package data generating unit 136 (hereinafter, also referred to as “CP (content package) data generating unit 136”) determines whether a requester who is a user 41 who requests the browsing is the same as a generator who is the user 41 who generates the content data. As a result, if it is determined that the requester is the same as the generator, the CP data generating unit 136 outputs the content data which is requested to be browsed to the user 41 regardless of the presence of the time stamp. That is, the CP data generating unit 136 searches for all content data which is requested to be browsed from the content data management table and outputs all content data to the transmitting and receiving unit 11. The transmitting and receiving unit 11 outputs the content data to the user terminal 40 of the requester.

In the meantime, if it is determined that the requester is different from the generator, the CP data generating unit 136 outputs only content data to which the time stamp is allocated, among the content data which is requested to be browsed, to the requester. Further, as a case when the CP data generating unit 136 determines as described above, other than a case when the user 41 requests the browsing of the content data of other users 41, a case when the user 41 requests to browse without logging in is also considered.

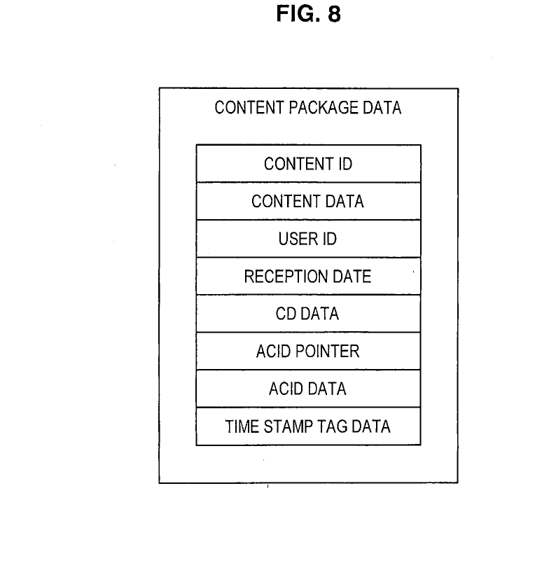

Specifically, the CP data generating unit 136 searches for data indicating that the time stamp status data indicates that “the time stamp has been obtained”, among the content data which is requested to be browsed, from the content data management table. Further, the CP data generating unit 136 connects the searched content data and a content ID, a user ID, reception date data, CD data, an ACID pointer, ACID data, and the time stamp tag data which are stored in the same row as the content data to generate the CP data. A data structure of the CP data is illustrated in FIG. 8. Further, the CP data generating unit 136 outputs the CP data to the transmitting and receiving unit 11 and the transmitting and receiving unit 11 outputs the CP data to the user terminal 40 of the requester. In addition, the ACID data which configures the CP data may include CID data which is generated from content data which the requester does not request the browsing. However, the CID data is generated by hashing the content data so that even though such CIP data is received, the browser may browse original content data. In other words, the content sharing server 10 may not allow the requester to browse content data other than the content data which the requester requests the browsing.

The verifying unit 14 illustrated in FIG. 3 verifies the time stamp tag data. Specific processings will be described below.

### 1-4. PROCESSING BY INFORMATION PROCESSING SYSTEM

### [Overall Processing]

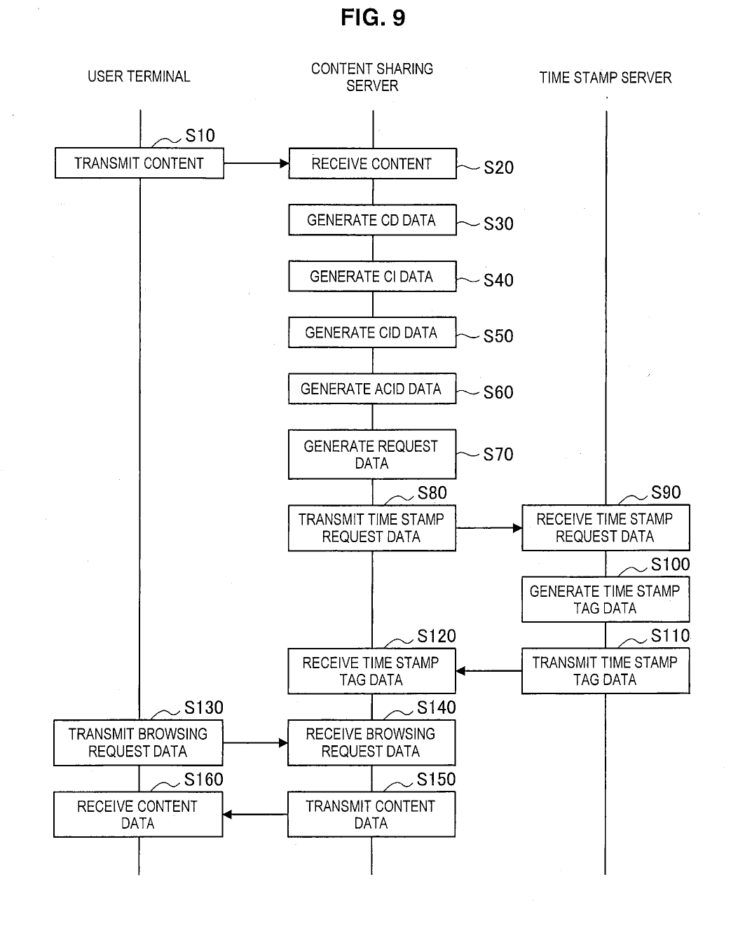

Next, the overall processing by the information processing system 100 will be described with reference to FIG. 9. Prior to the processing, each user 41 logs in the content sharing server 10. Specifically, each user 41 inputs the account and the password in his/her own user terminal 40. Each user terminal 40 outputs the input data to the content sharing server 10. The CD data generating unit 131 of the content sharing server 10 compares the data output from each user terminal 40 and an account management table which is not illustrated (a table which compares the account and the password and records the account and the password) to determine whether the data is correct. If the data output from the user terminal 40 is correct, the CD data generating unit 131 transmits data indicating that login is allowed to the user terminal 40. By doing this, the login operation is performed. In contrast, if the data output from the user terminal 40 is wrong, the CD data generating unit 131 outputs request data urging to reinput the account and the password to the user terminal 40.

In step S10, the user terminal 40 outputs content data which is created by the user 41 to the content sharing server 10. Here, to the content data, identification data which uniquely specifies the user 41 who generates the content data on the information processing system 100, for example, an account of the user 41 is added.

In step S20, the transmitting and receiving unit 11 receives the content data and outputs the content data to the CD data generating unit 131.

In step S30, the CD generating unit 131 generates a row for the content data in the content data management table illustrated in FIG. 5 and stores the content data in the row. Further, the CD generating unit 131 generates a content ID and reception date data and stores the content ID and the reception date data in the row for the content data together with the user ID.

Further, the CD generating unit 131 inputs the content data in the hash function to generate the CD data and stores the CD data in the row for the content data.

Further, the CD generating unit 131 stores an initial value indicating that data is undecided in an area for the ACID pointer, an area for the ACID data, and an area for the time stamp tag data, among respective areas which configure the row for the content data. In addition, the CD generating unit 131 stores an initial value indicating that “a time stamp is not obtained” in an area for the time stamp status data.

The CD generating unit 131 outputs the content ID, the user ID, the reception date data, and the CD data to the CI data generating unit 132.

In step S40, the CI data generating unit 132 connects the content ID, the user ID, the reception date data, and the CD data to generate CI data illustrated in FIG. 6. The CI generating unit 132 outputs the CI data to the CID data generating unit 133.

In step S50, the CID data generating unit 133 inputs the CI data in the hash function to generate the CID data. The CID data generating unit 133 outputs the CID data and a content ID corresponding to the CID data to the ACID data generating unit 134.

In step S60, the ACID data generating unit 134 stands by until the CID data is allocated to all content data which is received by the transmitting and receiving unit 11 within a predetermined time (for example, one minute). The ACID data generating unit 134 connects the CID data which is allocated while in standby to generate ACID data. The ACID generating unit 134 determines a storage target row in which the ACID data is stored based on the content ID included in the CID data which is allocated while in standby. Specifically, the ACID data generating unit 134 determines a row indicated by the content ID as the storage target row. Further, the ACID data generating unit 134 generates an ACID pointer for every storage target row. The ACID pointer is a pointer which indicates where the CID data obtained from the CD data in the storage target row is located in the ACID data. The ACID data generating unit 134 stores the generated ACID data and the ACID pointer in the storage target row. Next, the ACID data generating unit 134 outputs the ACID data to the request data generating unit 135.

In step S70, the request data generating unit 135 inputs the ACID data received from the ACID data generating unit 134 in the hash function to generate DACID data. Further, the request data generating unit 135 outputs the time stamp request data which requests the time stamp and the DACID data to the transmitting and receiving unit 11 and changes the time stamp status data of a row in which the ACID data is stored into data indicating “while the time stamp is requested”.

In step S80, the transmitting and receiving unit 11 outputs the time stamp request data and the DACID data to the time stamp allocating server 20.

In step S90, the time stamp allocating server 20 receives the time stamp request data and the DACID data.

In step S100, the time stamp allocating server 20 allocates the time stamp to the DACID data based on the time stamp request data. Specifically, the time stamp allocating server 20 generates time stamp tag data illustrated in FIG. 7.

In step S110, the time stamp allocating server 20 outputs the generated time stamp tag data to the content sharing server 10.

In step S120, the transmitting and receiving unit 11 receives the time stamp tag data output from the time stamp allocating server 20 and outputs the time stamp tag data to the request data generating unit 135.

The request data generating unit 135 stores the time stamp tag data in the row in which the ACID data is stored. Further, the request data generating unit 135 changes the time stamp status data of the row in which the time stamp tag data is stored into data indicating that “the time stamp is completely obtained”. In addition, the request data generating unit 135 outputs the row in which time stamp tag data is newly stored to the verifying unit 14, which will be described below to request a verification processing.

In step S130, the user 41 (requester) requests the content sharing server 10 to browse the content data. Specifically, the user 41 presents his or her own account and password to the system to perform the login processing and then inputs data specifying a generator who generates content data which the user wants to browse, for example, a user name of the generator to the user terminal 40. Correspondingly to this, the user terminal 40 outputs the input data to the content sharing server 10 as browsing request data. Here, the browsing request data includes identification data which uniquely specifies the requester and the generator on the information processing system 100.

In step S140, the transmitting and receiving unit 11 receives the browsing request data and outputs the browsing request data to the CP data generating unit 136.

In step S150, the CP data generating unit 136 searches for predetermined content data from the content data management table and outputs the content data to the transmitting and receiving unit 11, based on the browsing request data. The transmitting and receiving unit 11 outputs the content data to the user terminal 40 of the requester.

In step S160, the user terminal 40 of the requester receives the content data and displays the content data on the display 401. Details of the processings of steps S140 to S160 will be described below.

### [Processings of Steps S140 to S160]

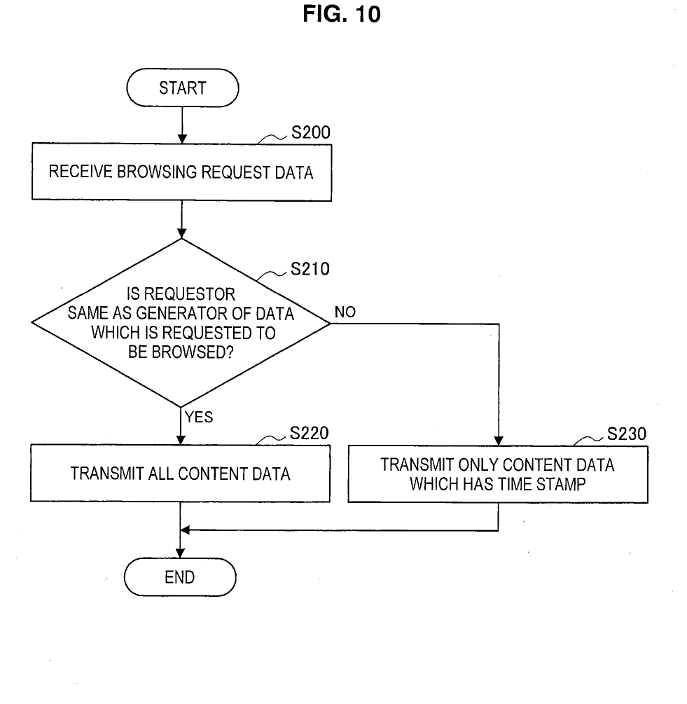

Next, details of the processings of steps S140 to S160 will be described with reference to FIG. 10.

In step S200, the transmitting and receiving unit 11 receives the browsing request data and outputs the browsing request data to the CP data generating unit 136.

In step S210, the CP data generating unit 136 determines whether the requester is the same as the generator who generates the content data which is requested to be browsed, based on the browsing request data. If it is determined that the requester is the same as the generator, the CP data generating unit 136 proceeds to step S220 and if it is determined that the requester is different from the generator, the CP data generating unit 136 proceeds to step S230.

In step S220, the CP data generating unit 136 outputs the content data which is requested to be browsed to the user terminal 40 of the requester regardless of the presence of the time stamp. That is, the CP data generating unit 136 searches for all content data which is requested to be browsed (that is, all content data which is uploaded by the generator) from the content data management table and outputs all content data to the transmitting and receiving unit 11. The transmitting and receiving unit 11 outputs the content data to the user terminal 40 of the requester and the user terminal 40 of the requester displays the received content data on the display 401.

In step S230, the CP data generating unit 136 outputs only the content data to which a time stamp is allocated, among the content data which is requested to be browsed, to the user terminal 40 of the requester.

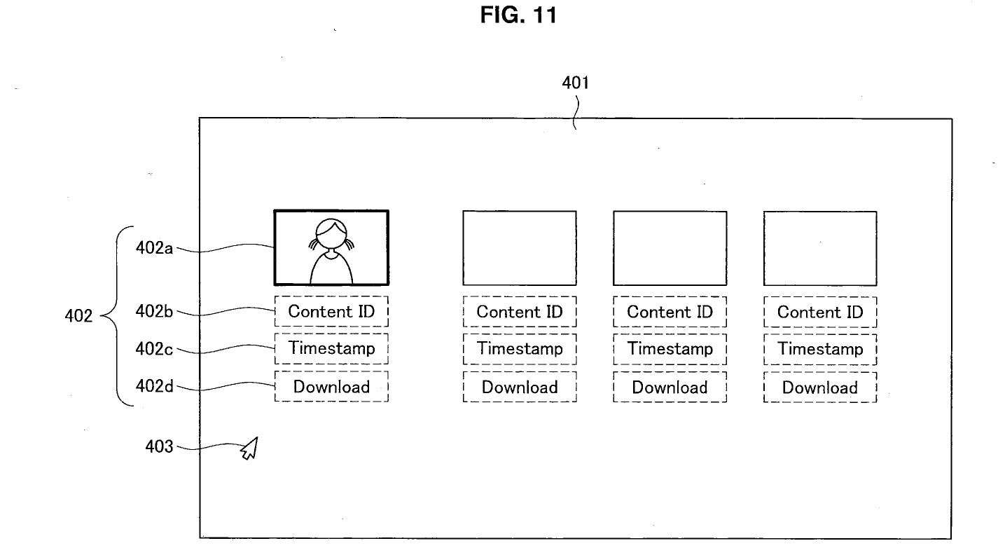

Specifically, the CP data generating unit 136 searches for data indicating that the time stamp status data indicates that “the time stamp has been obtained”, among the content data which is requested to be browsed, from the content data management table. Further, the CP data generating unit 136 connects the searched content data and a content ID, a user ID, reception date data, CD data, an ACID pointer, ACID data, and the time stamp tag data which are stored in the same row as the content data to generate the CP data. Next, the CP data generating unit 136 outputs the CP data to the transmitting and receiving unit 11 and the transmitting and receiving unit 11 outputs the CP data to the user terminal 40 of the requester. The user terminal 40 displays the content data on the display 401, based on the CP data. A display example at this time is illustrated in FIG. 11. On the display 401, one or a plurality of content information images 402 which includes a content data display area 402a, a content ID display area 402b, a time stamp display button 402c, and a download button 402d is displayed. Each of the content information images 402 corresponds to different content data.

In the content data display area 402a of the content information image 402, thumb nails of content data corresponding to the content information image 402 are displayed. If a mouse is clicked in a state when a mouse pointer 403 is overlaid with the content data display area 402a of the content information image 402, the user terminal 40 displays the content data corresponding to the content information image 402 on the display 402. Further, the content data itself may be displayed in the content data display area 402a.

In the content ID display area 402b of the content information image 402, the content ID of the content data corresponding to the content information image 402 is displayed.

If the mouse is clicked in a state when the mouse pointer 403 is overlaid with the time stamp display button 402c of the content information image 402, the user terminal 40 displays the time stamp (for example, time stamp date data, signature data, and a user ID of a user who generates the content) corresponding to the content information image 402 on the display 402.

If the mouse is clicked in a state when a mouse pointer 403 is overlaid with the download button 402d of the content information image 402, the user terminal 40 records the content and the CP data including the time stamp in a storage device which is mounted in or connected to the user terminal 40.

### [Verification Processing]

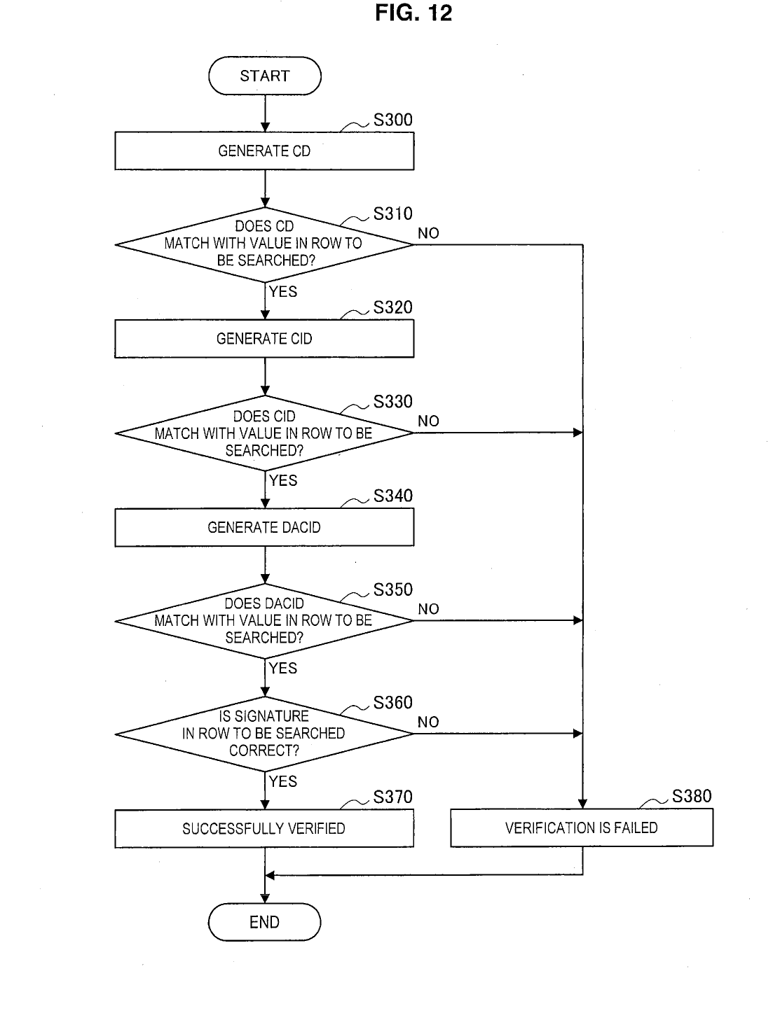

Next, a verification processing which is performed by the verifying unit 14 will be described with reference to FIG. 12. The verification processing is a processing that determines whether data recorded in the content data management table is correct or wrong. The verification processing starts by transmitting a request the verification processing to the verifying unit 14 when the request data generating unit 135 receives the time stamp tag data from the time stamp allocating server 20. Further, as described below, the verification processing is also performed by the request from the user. In this case, it is determined whether the data presented by the user is correct or wrong, rather than the data recorded in the content data management table.

In step S300, the verifying unit 14 determines a row corresponding to the content which newly obtains time stamp tag data in the content data management table, which is presented together with the request for the verification processing from the request data generating unit 135 as a verification target row. The verifying unit 14 inputs the content data in the search target row in the hash function to generate the CD data.

In step S310, the verifying unit 14 determines whether the generated CD data matches with the CD data in the search target row. If it is determined that the data match with each other, the verifying unit 14 proceeds to step S320 and if it is determined that the data do not match, the verifying unit 14 proceeds to step S380.

In step S320, the verifying unit 14 connects a user ID, a content ID, and reception date data of the search target row to the generated CD data to generate the CI data. Further, the verifying unit 14 inputs the generated CI data in the hash function to generate the CID data.

In step S330, the verifying unit 14 determines whether the generated CID data matches with the CID data indicated by the ACID pointer in the search target row. If it is determined that the data match with each other, the verifying unit 14 proceeds to step S340 and if it is determined that the data do not match, the verifying unit 14 proceeds to step S380.

In step S340, the verifying unit 14 inputs the ACID data in the search target row in the hash function to generate the DACID data.

In step S350, the verifying unit 14 determines whether the DACID data matches with the DACID data in the search target row (that is, DACID data in the time stamp tag data). If it is determined that the data match with each other, the verifying unit 14 proceeds to step S360 and if it is determined that the data do not match, the verifying unit 14 proceeds to step S380.

In step S360, the verifying unit 14 determines whether the signature data in the search target row is correct signature data for other elements in the time stamp tag, that is, a time stamp authority ID, time stamp date data, and the DACID, based on the verification function. Here, a known verification function may be arbitrarily used as the verification function. If it is determined that the signature data in the verification target row is correct signature data, the verifying unit 14 proceeds to step S370 and if it is determined that the signature data in the verification target row is wrong signature data, the verifying unit 14 proceeds to step S380.

In step S370, the verifying unit 14 determines that the data of the verification target row is correct (that is, the verification is successful) and records the corresponding determination data in the verification target row.

In step S380, the verifying unit 14 determines that the data of the verification target row is wrong (that is, the verification is failed) and records the corresponding determination data in the verification target row.

As a method of using the determination data which is a result of the verification processing, various methods are considered. For example, the CP data generating unit 136, in the above step S230, may output only data whose verification processing is successful, among the content package data, to the user terminal 40. Further, a CD data creation processing of step S30 of FIG. 9 may be performed on the content whose verification processing is failed, again.

As described above, according to the first embodiment, when the time stamp is allocated to the content data, the content sharing server 10 outputs the content data to a user terminal 40 other than the user terminal 40 which outputs the content data, among the plurality of user terminals 40.

By doing this, even when a user 41 of the other user terminal 40 uses the content data without authorization, the date is later than a date indicated by the time stamp so that a generator of the content data may allege that the user is a generator of the content data, based on the time stamp.

Therefore, the content sharing server 10 may protect content data which is published to a third party other than the generator of the content data.

Further, even though the time stamp is not allocated to the content data, the content sharing server 10 outputs the content data to the user terminal 40 which outputs the content data. By doing this, even when the time stamp is not allocated to the content data, the generator of the content data may check contents of the content data.

Further, the content sharing server 10 requests the time stamp allocating server 20 to collectively allocate the time stamp to the content data received from the user terminal 40 within a predetermined time. Therefore, the content sharing server 10 may reduce the number of requesting the time stamp as compared with a case when the time stamp is requested whenever the content data is received from the user terminal 40 so that the processing load of the content sharing server 10 may be reduced.

Further, the content sharing server 10 also outputs the time stamp tag data which is allocated to the content data to the user terminal 40 of the requester in addition to the content data so that the requester can check contents of the time stamp tag data.

### 1-5. VARIOUS MODIFIED EXAMPLES

Next, various modified examples will be described.

### First Modified Example

In a first modified example, the request data generating unit 135 does not output next time stamp request data until the time stamp tag data is received from the time stamp allocating server 20 after outputting the time stamp request data to the time stamp allocating server 20.

The ACID data generating unit 134 connects the CID data received from the CID data generating unit 133 until the request data generating unit 135 receives the time stamp tag data after the request data generating unit 135 outputs the time stamp request data to the time stamp allocating server 20 to generate the ACID data.

If the time stamp tag data is received, the request data generating unit 135 inputs the ACID data in the hash function to generate the DACID data and outputs the DACID data and next time stamp request data to the time stamp allocating server 20.

According to the first modified example, the time stamp which is requested is always one so that it is easy to manage a state (for example, management of the time stamp status data).

### Second Modified Example

In a second modified example, the CID data generating unit 133 directly outputs the CID data to the request data generating unit 135 and the request data generating unit 135 requests time stamp tag data for each CID data from the time stamp allocating server. That is, the content sharing server 10 requests the time stamp from the time stamp allocating server 20 whenever the content data is received from the user terminal 40.

According to the second modified example, the content sharing server 10 may reduce a difference between a time when the content data is received and a time when the time stamp is issued and reduce a standby time until the content data is published to the third party after uploading the content data.

### Third Modified Example

In a third modified example, the requester also inputs whether the time stamp tag data is necessary in the user terminal 40 when the content data is requested to be browsed. The user terminal 40 includes data indicating whether the time stamp tag data is necessary in the above browsing request data to be output to the content sharing server 10. When the browsing request data includes data indicating that the time stamp tag data is necessary, the CP data generating unit 136 generates the CP data including the time stamp tag data and the content data to output the CP data to the user terminal 40 of the requester.

According to the third modified example, the content sharing server 10 may output the time stamp tag data to a requester who needs the time stamp tag data. By doing this, the content sharing server 10 divides content storage, a sharing service, and a content certifying service (certification service by the time stamp) to be services by separate contracts.

### Fourth Modified Example

A fourth modified example allows the generator of the content data to arbitrarily select whether the time stamp is necessary.

That is, the content sharing server 10 prepares a contract of a type 1 which obtains the time stamp by default and a contract of a type 2 which does not obtain a time stamp by default and allows the user 41 to select any one of types when a contract is established with the user d41. A result of the selection is recorded, for example, in the above-mentioned account management table.

Further, if the time stamp is not necessary in the content data when the content data is uploaded, a contractor type 1 inputs the corresponding time stamp unnecessary data (flag) to the user terminal 40. For example, the user terminal 40 displays a check box of “time stamp unnecessary” on the display 401 and if the time stamp is unnecessary, the contractor type 1 inputs a check in the check box. When the time stamp unnecessary data is input, the user terminal 40 outputs the time stamp unnecessary data to the content sharing server 10 together with the content data. If the time stamp unnecessary data is included in the content data, the content sharing server 10 does not request the time stamp from the time stamp allocating server 20. In contrast, if the time stamp unnecessary data is not included in the content data, the content sharing server 10 requests the time stamp from the time stamp allocating server 20 by default. Specifically, if the time stamp unnecessary data is included in the content data, the request data generating unit 135 does not include the CID data obtained from the content data in the DACID but if the time stamp unnecessary data is not included in the content data, the CID data obtained from the content data is included in the DACID.

In the meantime, if the time stamp is necessary in the content data when the content data is uploaded, a contractor type 2 inputs the corresponding time stamp necessary data (flag) to the user terminal 40. For example, the user terminal 40 displays a check box of “time stamp necessary” on the display 401 and if the time stamp is necessary, the contractor type 2 inputs a check in the check box. When the time stamp necessary data is input, the user terminal 40 outputs the time stamp necessary data to the content sharing server 10 together with the content data. If the time stamp necessary data is included in the content data, the request data generating unit 135 requests the time stamp from the time stamp allocating server 20. In contrast, if the time stamp necessary data is not included in the content data, the request data generating unit 135 does not request the time stamp from the time stamp allocating server 20 by default. Specifically, if the time stamp necessary data is included in the content data, the request data generating unit 135 includes the CID data obtained from the content data in the DACID but if the time stamp necessary data is not included in the content data, the CID data obtained from the content data is not included in the DACID.

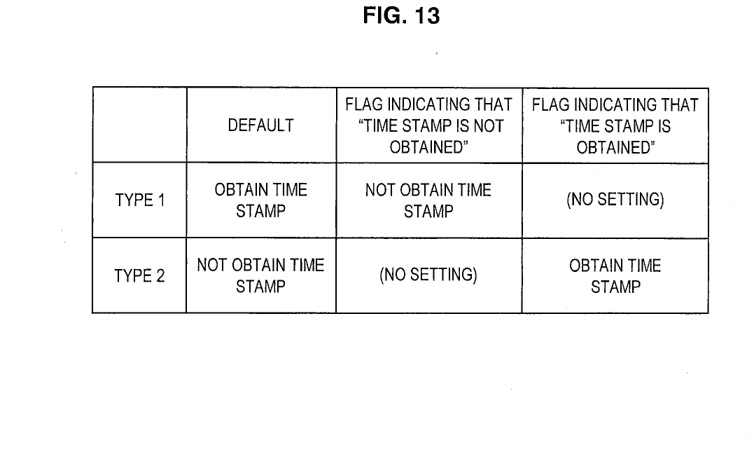

A correlation of a type of contract, a type of flag, and the presence of the time stamp request to the time stamp allocating server 20 is illustrated in FIG. 13.

According to the fourth modified example, when the user terminal 40 which outputs the content data makes a request for obtaining the time stamp, the content sharing server 10 may request the time stamp from the time stamp allocating server 20 so that it is possible to obtain the time stamp to which an intention of the user 41 is reflected. Further, the content sharing server 10 sets the necessity of the time stamp by default so that if there is a request which is different from the default, it is sufficient for the user 41 to input the corresponding data in the user terminal 40. By doing this, the content sharing server 10 may provide a simple method of designating a necessity of time stamp to the user 41. In order to generate the time stamp, a cost for calculating a hash value of the content is required so that it is possible to reduce the cost for a content which does not require the time stamp.

### 2. Second Embodiment

### 2-1. Schematic Configuration of Information Processing System

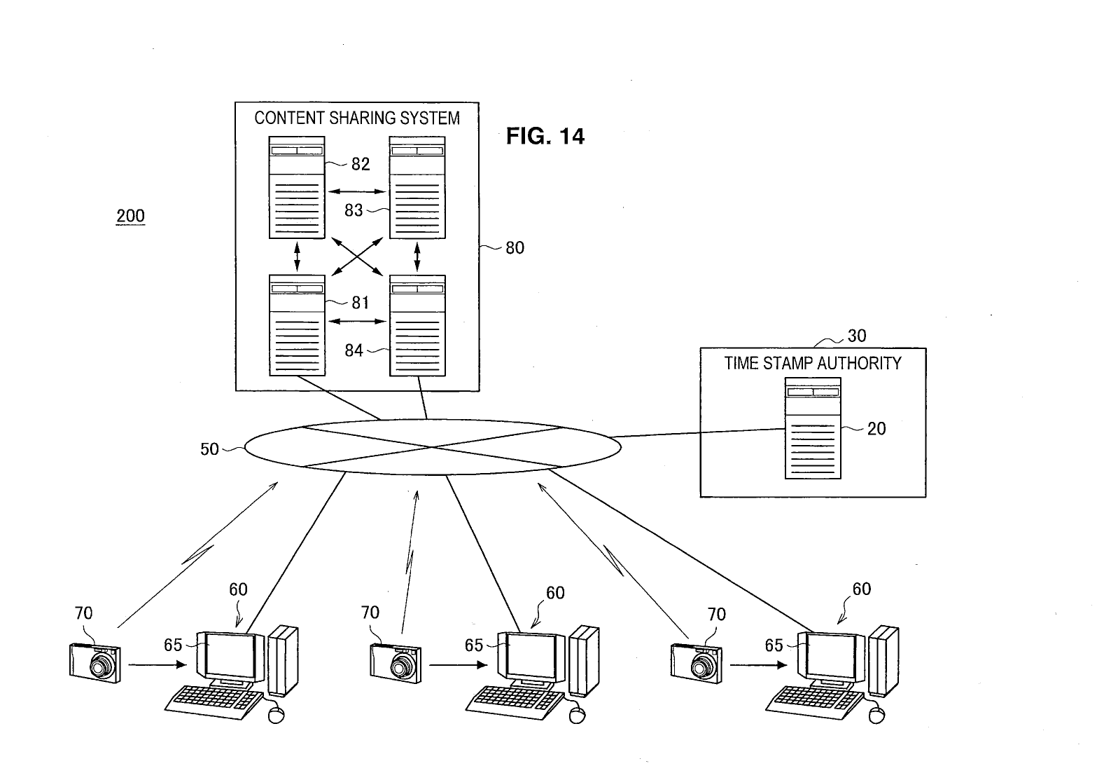

Next, a second embodiment of the present disclosure will be described. First, referring to FIG. 14, a schematic configuration of an information processing system 200 according to a second embodiment will be described. The information processing system 200 includes a content sharing system 80, a time stamp allocating server (time stamp allocating unit) 20, a plurality of user terminals (user devices) 60, a plurality of content generating devices 70, and a network 50 which connects the above units.

The content sharing system 80 is owned by a manager which manages and publishes content data to manage the content data, request a time stamp, and publish content data to which the time stamp is allocated. That is, the content sharing system 80 allows a plurality of servers to share the function of the content sharing server 10 according to the first embodiment.

The user terminal 60, for example, are personal computers and may be manipulated by different users. The user terminal 60 may be attachable to the content generating device 70 through a connection cable and if the content generating device 70 is connected thereto, the user terminal 60 obtains content data data from the content generating device 70 and transmits the content data to the content sharing system 80. Further, the user terminal 60 may perform wireless communication with the content generating device 70.

Further, the user may request the content sharing system 80 to browse the content data using the user terminal 60. The content sharing system 80 outputs the content data which is requested to be browsed to the user terminal 60. The user terminal 60 displays the content data received from the content sharing system 80 on the display unit 65. The user terminal 60 is not limited to a personal computer illustrated in FIG. 14. For example, the user terminal 60 may be a television receiver, a car navigation, a portable phone, a game machine, a music player, a smart phone, or a smart tablet.

The content generating device 70 is, for example, a video camera and generates content data, for example, image data by the manipulation of the user. Further, the content generating device 70 may transmit the content data and CD data to the content sharing system 80. Further, the content generating device 70 may be attachable to the user terminal 60 through a connection cable. When the content generating device 70 is connected to the user terminal 60, the content generating device 70 may transmit the content data to the user terminal 60. Further, if the content generating device 70 generates content data, communicates with the content sharing system 80, and is attachable to the user terminal 60, any device may be used therefor. For example, the content generating device 70 may be a portable phone, a smart phone, or a smart tablet.

### 2-2. Detailed Configuration of Information Processing System

### [Configuration of User Terminal]

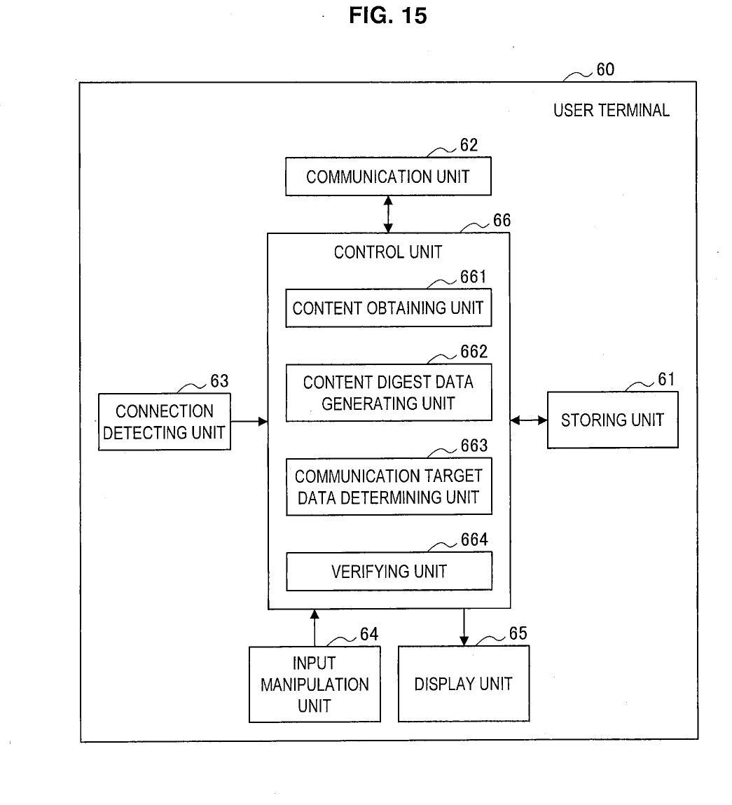

Next, a detailed configuration of the information processing system will be described. First, referring to FIG. 15, a configuration of the user terminal (information processing apparatus) 60 will be described. The user terminal 60 includes a storing unit 61, a communication unit 62, a connection detecting unit 63, an input manipulation unit 64, a display unit 65, and a control unit 66. Further, the user terminal 60 includes various hardware configurations such as a CPU, a ROM, a RAM, a hard disk, a communication device, a keyboard, a mouse, a connector which is not illustrated, and a display and performs various processings when the CPU reads out and executes a program stored in the ROM. That is, a program which allows the user terminal 60 to implement the storing unit 61, the communication unit 62, the connection detecting unit 63, the input manipulation unit 64, the display unit 65, and the control unit 66 is stored in the ROM. The connector is a part to which the connection cable is connected.

The storing unit 61 stores data which is required for the user terminal 60 to perform various processings, for example, a program, image data, voice data, various public keys, and various public functions (for example, the above-described hash function). Further, the storing unit 61 stores identification data for identifying a user of the user terminal 60, for example, a user ID. The communication unit 62 communicates with the content sharing system 80 through the network 50. In addition, the communication unit 62 communicates with the content generating device 70 when the content generating device 70 is connected thereto.

The connection detecting unit 63 detects that the content generating device 70 is connected and outputs corresponding connection detecting data indicating that to the control unit 66. The input manipulation unit 64 is, for example, a keyboard and a mouse, and outputs input manipulating data in accordance with the input manipulation by the user to the control unit 66. The display unit 65 is a display and presents (outputs) various image data and voice data.

The control unit 66 controls individual components of the user terminal 60 and also functions as a content obtaining unit 661, a content digest data generating unit (CD data generating unit) 662, a communication target data determining unit 663, and a verifying unit 664. The content obtaining unit 661 obtains the content data from the content generating device 70 through the communication unit 62. The content digest data generating unit 662 inputs the content data in a hash function to generate a hash value of the content data, that is, CD data. The communication target data determining unit 663 determines communication target data to communicate with the content sharing system 80, among the content data and the CD data. Contents of the communication target data, that is, status data regarding a current communication status is allocated to the communication target data. The verifying unit 664 verifies whether content package data (CP data) provided from the content sharing server 80 is appropriate.

### [Configuration of Content Generating Device]

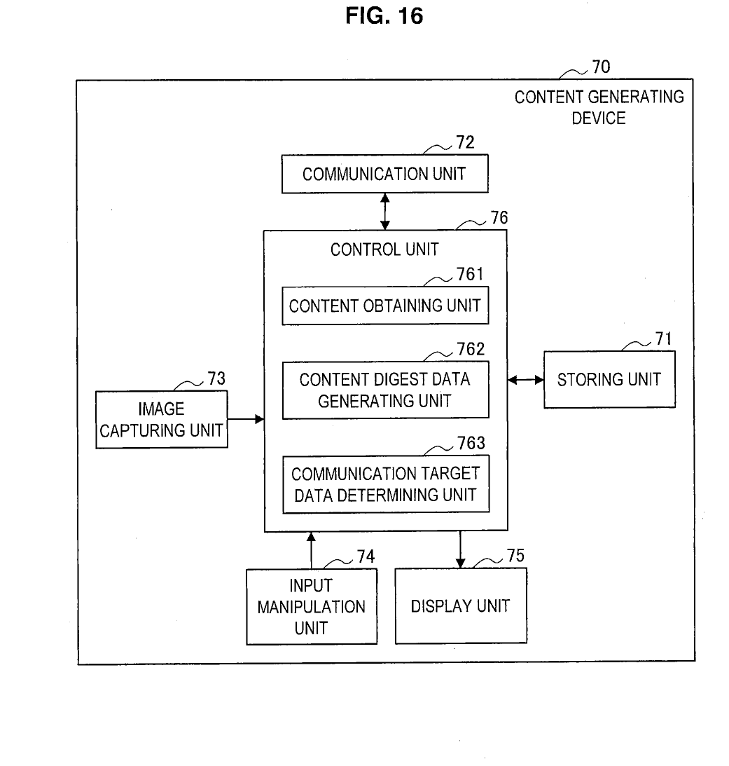

Next, referring to FIG. 16, a configuration of the content generating device (information processing apparatus) 70 will be described. The content generating device 70 includes a storing unit 71, a communication unit 72, an image capturing unit 73, an input manipulation unit 74, a display unit 75, and a control unit 76. Further, the content generating device 70 includes various hardware configurations such as a CPU, a ROM, a RAM, an image capturing device, a communication device, various buttons such as an image capturing button, a touch panel, a connector which is not illustrated, and a display and performs various processings when the CPU reads out and executes a program stored in the ROM. That is, a program which allows the content generating device 70 to implement the storing unit 71, the communication unit 72, the image capturing unit 73, the input manipulation unit 74, the display unit 75, and the control unit 76 is stored in the ROM. The connector is a part to which the connection cable is connected.

The storing unit 71 stores data which is required for the content generating device 70 to perform various processings, for example, a program, image data, voice data, various public keys, and various public functions (for example, the above-described hash function). Further, the storing unit 71 stores identification data for identifying the content generating device 70, for example, an MAC address. The communication unit 72 wirelessly communicates with the content sharing system 80 through the network 50. The communication unit 72 detects a width of a communication band with the content sharing system 80 and outputs communication band data regarding the detection result to the control unit 76. In addition, the communication unit 72 communicates with the user terminal 60 when the user terminal 60 is connected thereto.

The image capturing unit 73 captures surroundings of the content generating device 70 to generate image data, that is, content data and outputs the image data to the control unit 76. The input manipulation unit 74 is, for example, various buttons or touch panels and outputs input manipulating data in accordance with the input manipulation by the user to the control unit 76. The display unit 75 is a display and presents (outputs) various image data.

The control unit 76 controls individual components of the content generating device 70 and also functions as a content obtaining unit 761, a content digest data generating unit (CD data generating unit) 762, and a communication target data determining unit 763. The content obtaining unit 761 allows the image capturing unit 73 to generate content data and obtains the content data from the image capturing unit 73. The content digest data generating unit 762 inputs the content data in a hash function to generate a hash value of the content data, that is, CD data. The communication target data determining unit 763 determines communication target data to wirelessly communicate with the content sharing system 80, among the content data and the CD data. Contents of the communication target data, that is, status data regarding a current communication status is allocated to the communication target data.

### [Configuration of Content Sharing System]

Next, a configuration of the content sharing system 80 will be described. The content sharing system 80 allows a plurality of servers to share the function of the content sharing server 10 according to the first embodiment. That is, the content sharing system 80 includes a web server 81, a storage server 82, a database server 83, and a time stamp obtaining engine 84.

### [Configuration of Web Server]

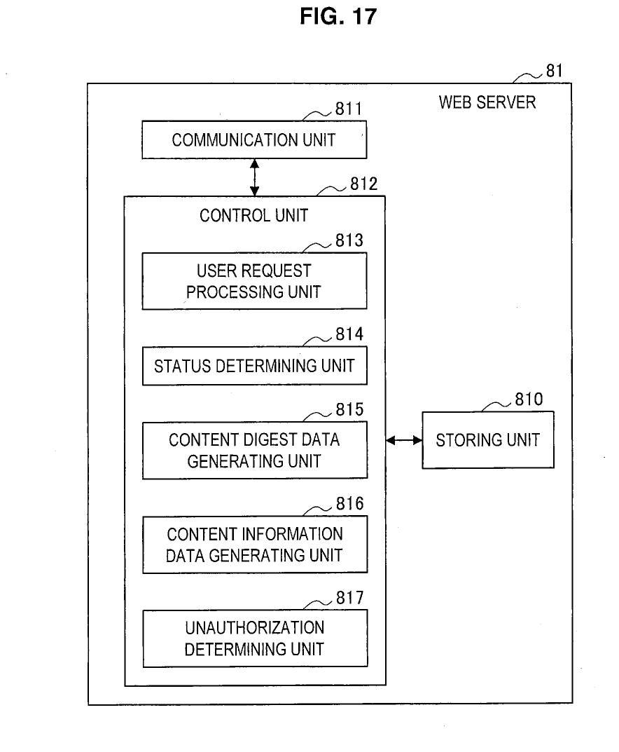

The web server (a first information processing apparatus) 81, as illustrated in FIG. 17, includes a storing unit 810, a communication unit 811, and a control unit 812. Further, the web server 81 includes various hardware configurations such as a CPU, a ROM, a RAM, a hard disk, and a communication device, and performs various processings when the CPU reads out and executes a program stored in the ROM. That is, a program which allows the web server 81 to implement the storing unit 810, the communication unit 811, and the control unit 812 is stored in the ROM.

The storing unit 810 stores various data which is required for the web server 81 to perform various processings, for example, a program, image data, voice data, various public keys, and various public functions (for example, the above-described hash function).

The storing unit 810 stores an MAC address related table in which the user ID and the MAC address are recorded so as to be associated with each other. Further, the storing unit 810 stores the CI data related table in which the content information data (CI data) and random number data are recorded so as to be associated with each other. The Cl data is a combination of the CD data and the user ID. That is, the CI data of the second embodiment is simpler than the CI data of the first embodiment (see FIG. 6). The random number data is associating data for associating the content data and the CD data (specifically, CD data in the CI data).

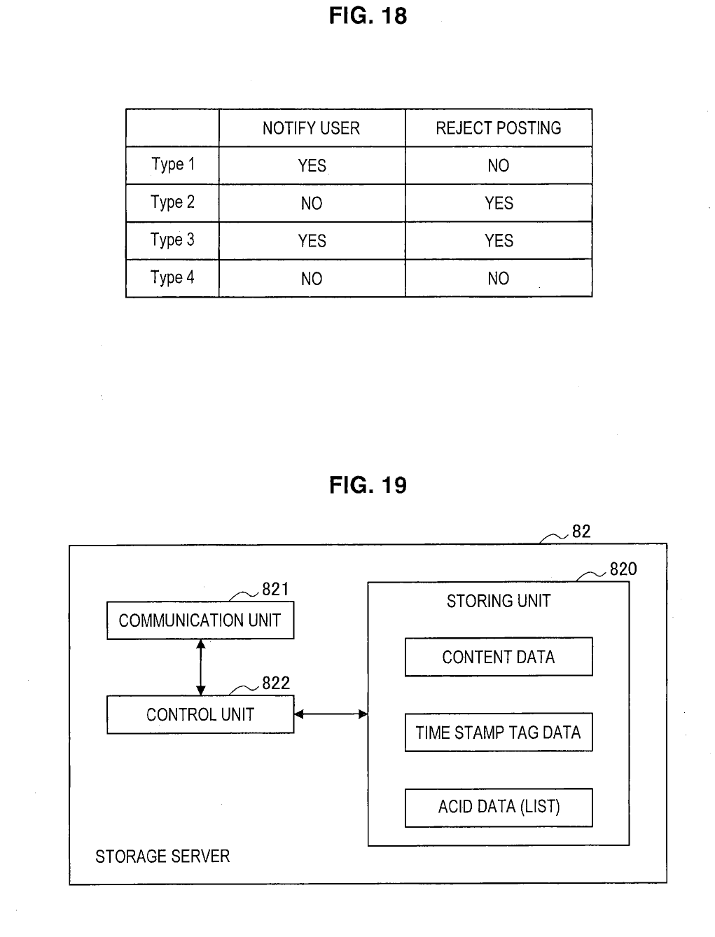

Further, the storing unit 810 stores an unauthorization processing determining table illustrated in FIG. 18. In the unauthorization processing determining table, a type of an unauthorization processing and contents of an unauthorization processing are recorded so as to be associated with each other. If content data transmitted (posted) from a user is unauthorized (that is, the content data posted from the user is similar to content data which is owned by another user), the unauthorization processing is performed. Here, there are four types of unauthorization processings. The unauthorization processing is classified into “notification to a user who possesses proper content data” and “rejection of posting of unauthorized content data” and whether to perform the classification may be varied for every type of unauthorization processing. The web server 81 or the user who posts the proper content data may arbitrarily determine which type of unauthorization processing is performed.

The communication unit 811 communicates with the user terminal 60 and the content generating device 70 through the network 50 and also communicates with other components of the content sharing system 80. The control unit 812 controls components of the web server 81 and also functions as a user request processing unit 813, a status determining unit 814, a content digest data generating unit 815, a content information data generating unit 816, and an unauthorization determining unit 817.

The user request processing unit 813 is a part which functions as a window with respect to the user and performs a processing in accordance with a request from the user and performs a response. For example, the user request processing unit 813 accepts login and posting of the content data, and publishes the content data.

The status determining unit 814 determines a communication status between the content sharing system 80 and the content generating device 70 based on the status data. The content digest data generating unit (CD data generating unit) 815 inputs the content data in the hash function to generate CD data. The content information data generating unit (CI data generating unit) 816 combines the user ID into the CD data to generate the CI data. That is, the CI data of the second embodiment is simpler than the CI data of the first embodiment (see FIG. 6). The unauthorization determining unit 817 determines whether the content data posted from the user is proper.

### [Configuration of Storage Server]

The storage server (a third information processing apparatus) 82, as illustrated in FIG. 19, includes a storing unit 820, a communication unit 821, and a control unit 822. Further, the storage server 82 includes various hardware configurations such as a CPU, a ROM, a RAM, a hard disk, and a communication device, and performs various processings when the CPU reads out and executes a program stored in the ROM. That is, a program which allows the storage server 82 to implement the storing unit 820, the communication unit 821, and the control unit 822 is stored in the ROM.

The storing unit 820 stores various data which is required for the storage server 82 to perform various processings, for example, programs. Further, the storing unit 820 stores the content data, time stamp tag data, and ACID data (list). The time stamp tag data and the ACID data are the same as those of the first embodiment. That is, the time stamp tag data includes a time stamp authority ID, time stamp date data, DACID data, and signature data. The DACID data is a hash value of the ACID data. The ACID data is an aggregation of the CID data, that is, a list of the CID data and the CID data is a hash value of the CI data.

The communication unit 821 communicates with other components of the content sharing system 80. The control unit 822 controls the components of the storage server 82.

### [Configuration of Database Server]

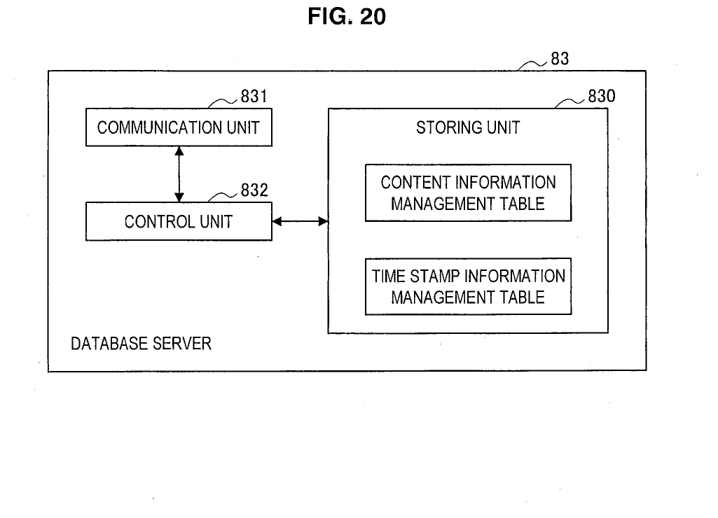

The database server (a fourth information processing apparatus) 83, as illustrated in FIG. 20, includes a storing unit 830, a communication unit 831, and a control unit 832. Further, the database server 83 includes various hardware configurations such as a CPU, a ROM, a RAM, a hard disk, and a communication device, and performs various processings when the CPU reads out and executes a program stored in the ROM. That is, a program which allows the database server 83 to implement the storing unit 830, the communication unit 831, and the control unit 832 is stored in the ROM.

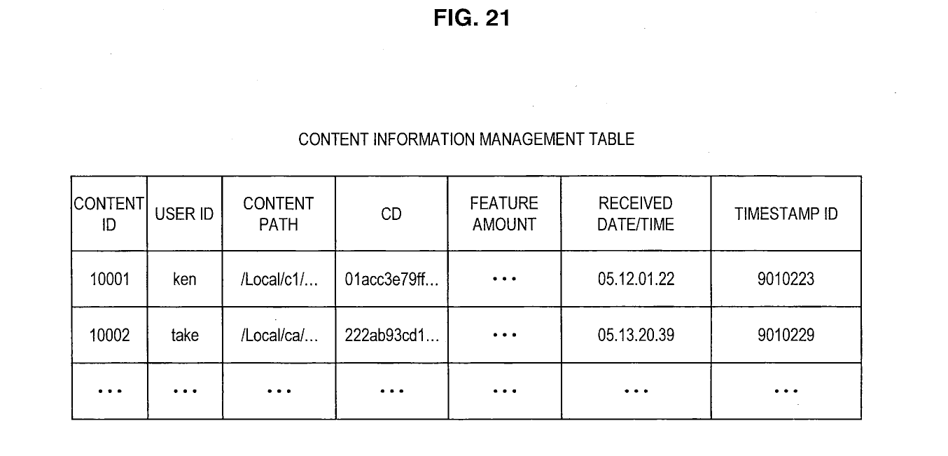

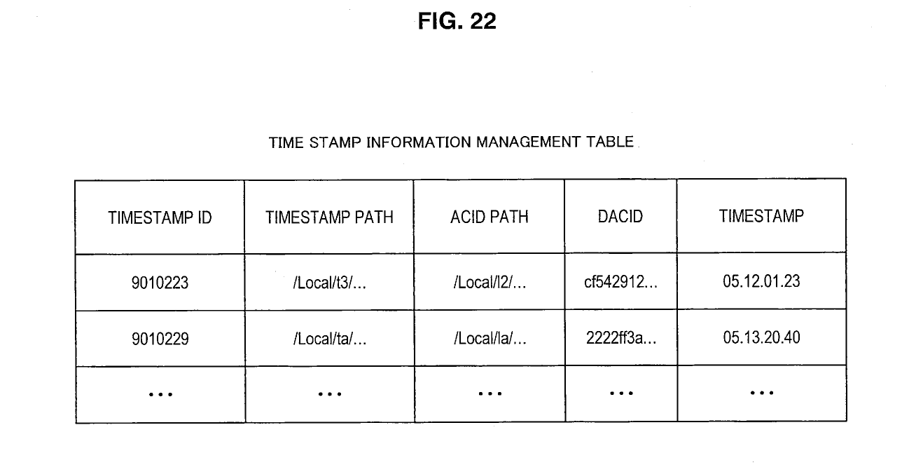

The storing unit 830 stores various data which is required for the database server 83 to perform various processings, for example, programs. Further, the storing unit 830 stores a content information management table illustrated in FIG. 21 and a time stamp information management table illustrated in FIG. 22.

In the content information management table, the content ID, the user ID, the content path data, the CD data, the feature amount data, the reception date data, and the time stamp ID are recorded so as to be associated with each other. The content ID is identification information for identifying the content data and the user ID is identification information for identifying the user. The feature amount data represents a feature amount of the content data, for example, is calculated by an SIFT algorithm. Specifics thereof will be described below. The content path data represents a location (address) of the content data in the storage server 82. The reception date data represents a date when the web server 81 receives the content data. The time stamp ID is identification information for identifying time stamp tag data.

In the time stamp information management table, the time stamp ID, the time stamp path data, the ACID path data, the DACID data, and the time stamp date data (time stamp time data) are recorded so as to be associated with each other. The time stamp path data represents a location (address) of a time stamp tag in the storage server 82. The ACID path data represents a location (address) of the ACID data in the storage server 82. The DACID data is a hash value of the ACID data. The time stamp date data represents a date when the time stamp is allocated to the content data. The content information management table and the time stamp information management table are associated with each other by the time stamp ID. Therefore, the database server 83 records the content ID, the content path data, and the time stamp path data so as to be associated with each other.

The communication unit 831 communicates with other components of the content sharing system 80. The control unit 832 controls the components of the database server 83.

### [Configuration of Time Stamp Obtaining Engine]

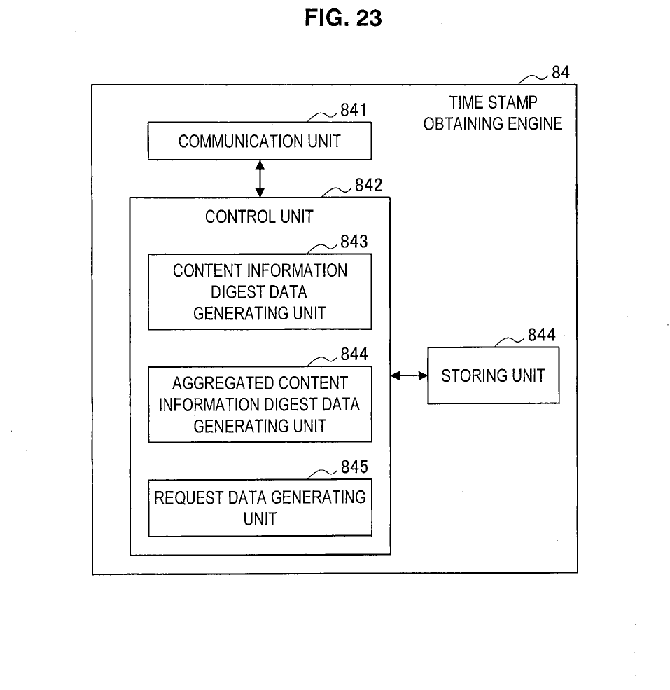

The time stamp obtaining engine (a second information processing apparatus) 84, as illustrated in FIG. 23, includes a storing unit 840, a communication unit 841, and a control unit 842. Further, the time stamp obtaining engine 84 includes various hardware configurations such as a CPU, a ROM, a RAM, a hard disk, and a communication device, and performs various processings when the CPU reads out and executes a program stored in the ROM. That is, a program which allows the time stamp obtaining engine 84 to implement the storing unit 840, the communication unit 841, and the control unit 842 is stored in the ROM.

The storing unit 840 stores various data which is required for the time stamp obtaining engine 84 to perform various processings, for example, programs. Further, the storing unit 840 stores a time stamp flag indicating whether appropriate time stamp tag data is obtained.

The communication unit 841 communicates with other components of the content sharing system 80. The control unit 842 controls components of the time stamp obtaining engine 84 and also functions as a content information digest data generating unit (CID data generating unit) 843, an aggregated content information digest data generating unit (ACID data generating unit) 844, and a request data generating unit 845. The CID data generating unit 843 inputs the CI data in a hash function to generate a hash value of the CI data, that is, CID data. An ACID data generating unit 844 generates data in which CID data is aggregated, that is, ACID data. The request data generating unit 845 inputs the ACID data in the hash function to generate DACID data. The request data generating unit 845 outputs time stamp request data which requests the time stamp and the DACID data to the communication unit 841. The communication unit 841 transmits the data to the time stamp allocating server 20. Therefore, the request data generating unit 845 requests the time stamp from the time stamp allocating server 20.

### 2-3. Processing by Information Processing System

### [Processing by Content Generating Device]

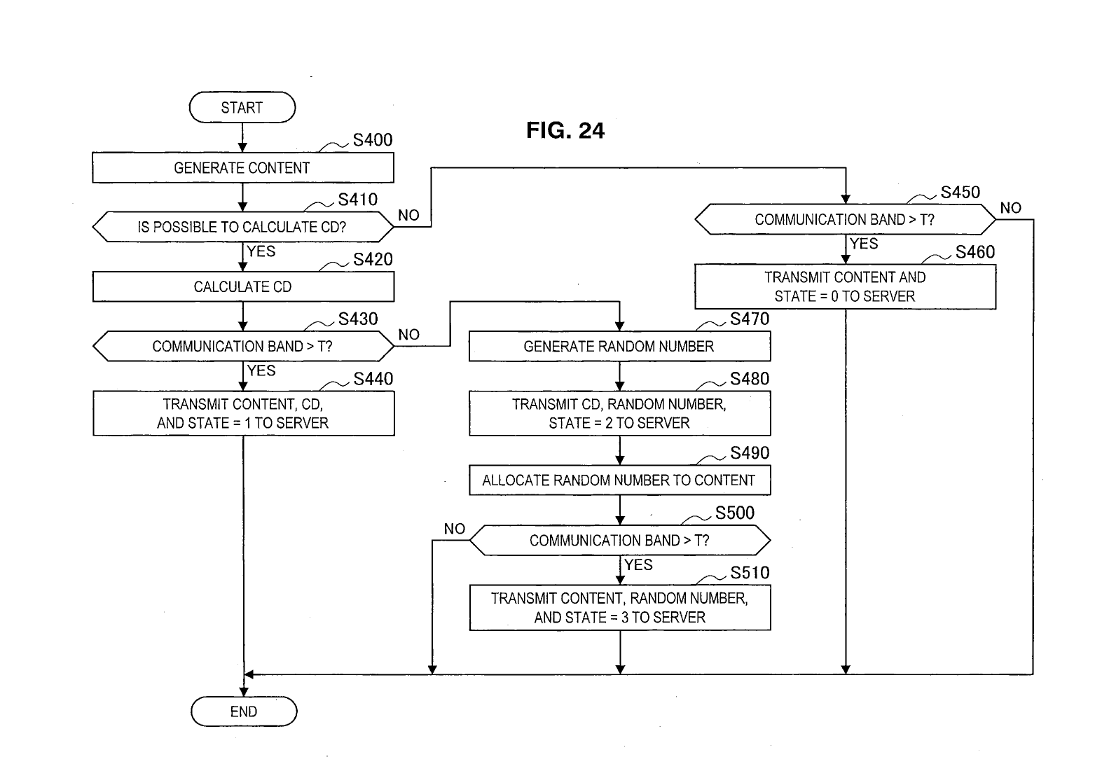

Next, a procedure of the processing by the information processing system 200 will be described. First, the procedure of the processing by the content generating device 70 will be described with reference to FIG. 24.

In step S400, the image capturing unit 73 generates image data, that is, content data and outputs the content data to the content obtaining unit 761. The content obtaining unit 761 stores the content data in the storing unit 71. Further, personal information data indicating personal information of the user (for example, positional information indicating a capturing location) may be allocated to the content data. The personal information data is stored, for example, in an Exif header of the content data.

In step S410, the content obtaining unit 761 determines whether the content generating device 70 includes a resource for generating the CD data, that is, a CD data generating unit 762. If it is determined that the content generating device 70 includes the CD data generating unit 762, the content obtaining unit 761 proceeds to step S420 and if it is determined that the content generating device 70 does not include the CD data generating unit 762, the content obtaining unit 761 proceeds to step S450.

In step S420, the CD data generating unit 762 obtains the content data from the storing unit 71 and inputs the content data in the hash function to generate the CD data. The CD data generating unit 762 stores the content data and the CD data in the storing unit 71 so as to be associated with each other.

In step S430, the communication unit 72 detects a width of a communication band with the web server 81 and outputs communication band data regarding the detection result to the communication target data determining unit 763. The communication target data determining unit 763 determines whether the width of the communication band is larger than a predetermined threshold value T. If it is determined that the width of the communication band is larger than the threshold value T, the communication target data determining unit 763 proceeds to step S440, and if it is determined that the width of the communication band is equal to or smaller than the threshold value T, the communication target data determining unit 763 proceeds to step S470.

In step S440, the communication target data determining unit 763 determines the content data and the CD data as communication target data and generates communication target data including the MAC address of the content generating device 70, the content data, the CD data, and status data indicating “1”. The communication target data determining unit 763 outputs the communication target data to the communication unit 72 and the communication unit 72 transmits the communication target data to the web server 81. Thereafter, the content generating device 70 ends the processing. Therefore, if the status data is “1”, the status data indicates a communication status where the content data and the CD data are transmitted to the web server 81.

In step S450, the communication unit 72 detects a width of a communication band with the web server 81 and outputs communication band data regarding the detection result to the communication target data determining unit 763. The communication target data determining unit 763 determines whether the width of the communication band is larger than a predetermined threshold value T. If it is determined that the width of the communication band is larger than the threshold value T, the communication target data determining unit 763 proceeds to step S460. In contrast, if it is determined that the width of the communication band is equal to or smaller than the threshold value T, the communication target data determining unit 763 stores unsent flag indicating that the content data is not transmitted in the storing unit 71 so as to be associated with the content data and ends the processing. In the latter case, the content data is transmitted to the web server 81 when the content generating device 70 is connected to the user terminal 60.

In step S460, the communication target data determining unit 763 determines the content data as communication target data and generates communication target data including the MAC address of the content generating device 70, the content data, and status data indicating “0”. The communication target data determining unit 763 outputs the communication target data to the communication unit 72 and the communication unit 72 transmits the communication target data to the web server 81. Thereafter, the content generating device 70 ends the processing. Therefore, if the status data is “0”, the status data indicates a communication status where the content data is transmitted to the web server 81.

In step S470, the communication target data determining unit 763 generates random number data as associating data for associating the content data and the CD data.

In step S480, the communication target data determining unit 763 determines the CD data as communication target data and generates communication target data including the MAC address of the content generating device 70, the CD data, a random number and status data indicating “2”. The communication target data determining unit 763 outputs the communication target data to the communication unit 72 and the communication unit 72 transmits the communication target data to the web server 81. Therefore, if the status data is “2”, the status data indicates a communication status where the CD data and the random number data are transmitted to the web server 81.

In step S490, the communication target data determining unit 763 stores the content data, the CD data, and the random number data in the storing unit 71 so as to be associated with each other. That is, the communication target data determining unit 763 allocates the random number data to the content data.

In step S500, the communication unit 72 detects a width of a communication band with the web server 81 again and outputs communication band data regarding the detection result to the communication target data determining unit 763. The communication target data determining unit 763 determines whether the width of the communication band is larger than a predetermined threshold value T. If it is determined that the width of the communication band is larger than the threshold value T, the communication target data determining unit 763 proceeds to step S510. In contrast, if it is determined that the width of the communication band is equal to or smaller than the threshold value T, the communication target data determining unit 763 stores unsent flag indicating that the content data is not transmitted in the storing unit 71 so as to be associated with the content data and ends the processing. In the latter case, the content data is transmitted to the web server 81 when the content generating device 70 is connected to the user terminal 60.

In step S510, the communication target data determining unit 763 determines the content data as communication target data and generates communication target data including the MAC address of the content generating device 70, the content data, a random number which is associated with the content data, and status data indicating “3”. The communication target data determining unit 763 outputs the communication target data to the communication unit 72 and the communication unit 72 transmits the communication target data to the web server 81. Thereafter, the content generating device 70 ends the processing. Therefore, if the status data is “3”, the status data indicates a communication status where the content data and the random number data are transmitted to the web server 81.

As described above, the content generating device 70 may transmit the CD data to the web server 81 as the communication target data so that the content sharing system 80 may save time and effort to generate CD data. By doing this, the processing load of the content sharing system 80 is reduced. Further, the content generating device 70 determines the communication target data based on the resource of the content generating device 70 and the width of the communication band with the web server 81. Therefore, the content generating device 70 may satisfactorily and rapidly transmit the communication target data to the web server 81. Further, the content generating device 70 automatically transmits at least one of the content data and the CD data at the time of generating the content data. Therefore, the content generating device 70 may narrow a gap between a date when the content data is generated and a date certified by the time stamp, that is, a date when the time stamp is allocated.

### [Processing by User Terminal]

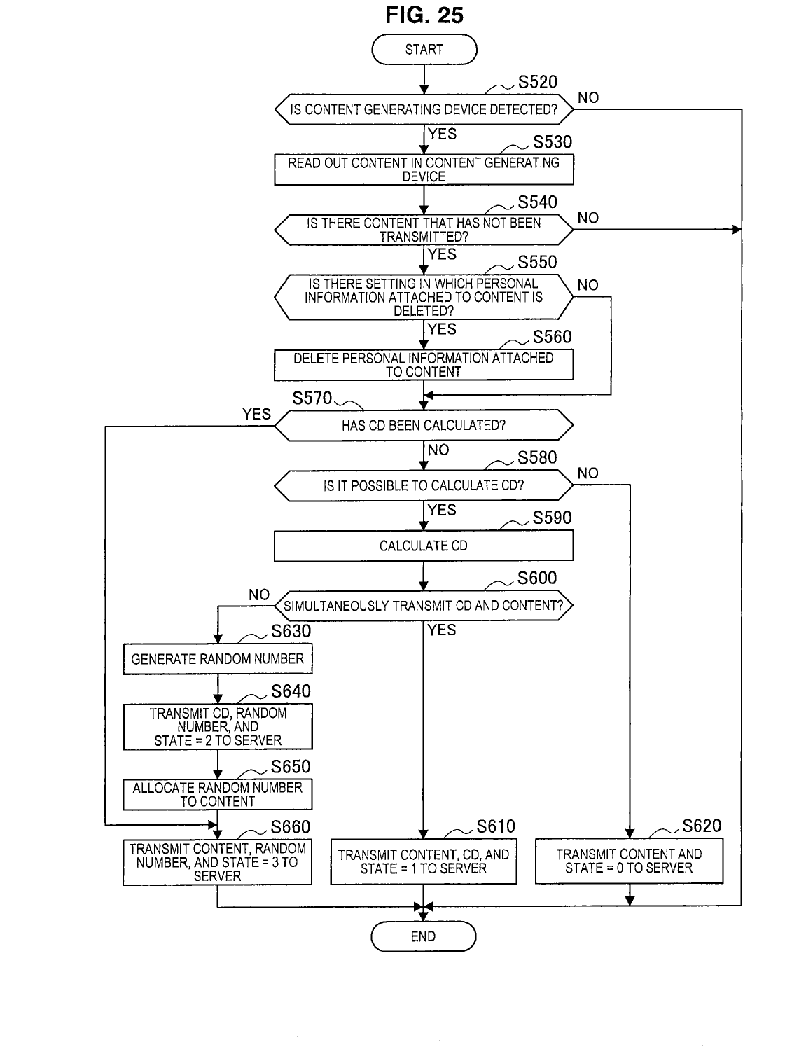

Next, the procedure of the processing by the user terminal 60 will be described with reference to FIG. 25. In step S520, the content obtaining unit 661 determines whether the connection detecting data is received from the connection detecting unit 63. If it is determined that the connection detecting data is received, the content obtaining unit 661 proceeds to step S530 and if it is determined that the connection detecting data is not received, the content obtaining unit 661 ends the processing.

In step S530, the content obtaining unit 661 accesses the content generating device 70 through the communication unit 62 and reads out the content data and various data associated with the content data from the storing unit 71. The content obtaining unit 661 stores the data in the storing unit 61.

In step S540, the content obtaining unit 661 determines whether there is unsent content data, that is, content data with which an unsent flag is associated. If it is determined that there is not transmitted content data, the content obtaining unit 661 proceeds to step S550 and if it is determined that there is no unsent content data, the content obtaining unit 661 ends the processing. The user terminal 60 performs a processing subsequent to step S550 on the unsent content data.

In step S550, the content obtaining unit 661 determines whether a setting that deletes personal information data attached to the content data is performed. Further, the user performs the input manipulation using the input manipulation unit 64 to perform the above setting. Set contents are stored in the storing unit 61. If it is determined that the setting is performed, the content obtaining unit 661 proceeds to step S560 and if it is determined that the setting is not performed, the content obtaining unit 661 proceeds to step S570.

In step S560, the content obtaining unit 661 deletes personal information data from the content data. The processings of steps S550 to S560 may be performed by the content generating device 70.

In step S570, the content obtaining unit 661 determines whether the CD data has been calculated, that is, the CD data is associated with the content data. If it is determined that the CD data has been calculated, the content obtaining unit 661 proceeds to step S660 and if it is determined that the CD data is not calculated, the content obtaining unit 661 proceeds to step S580.

In step S580, the content obtaining unit 661 determines whether the user terminal 60 includes a resource for generating the CD data, that is, the CD data generating unit 662. If it is determined that the user terminal 60 includes the CD data generating unit 662, the content obtaining unit 661 proceeds to step S590 and if it is determined that the user terminal 60 does not include the CD data generating unit 662, the content obtaining unit 661 proceeds to step S620.

In step S590, the CD data generating unit 662 obtains the content data from the storing unit 61 and inputs the content data in the hash function to generate the CD data. The CD data generating unit 662 stores the content data and the CD data in the storing unit 61 so as to be associated with each other.

In step S600, the communication target data determining unit 663 determines whether a setting that simultaneously transmits the content data and the CD data to the web server 81 is performed. Further, the user performs the input manipulation using the input manipulation unit 64 to perform the above setting. Set contents are stored in the storing unit 61. If it is determined that the setting is performed, the communication target data determining unit 663 proceeds to step S610 and if it is determined that the setting is not performed, the communication target data determining unit 663 proceeds to step S630.

In step S610, the communication target data determining unit 663 determines the content data and the CD data as communication target data and generates communication target data including the user ID, the content data, the CD data, and status data indicating “1”. The communication target data determining unit 663 outputs the communication target data to the communication unit 62 and the communication unit 62 transmits the communication target data to the web server 81. Thereafter, the user terminal 60 ends the processing.

In step S620, the communication target data determining unit 663 determines the content data as communication target data and generates communication target data including the user ID, the content data, and status data indicating “0”. The communication target data determining unit 663 outputs the communication target data to the communication unit 62 and the communication unit 62 transmits the communication target data to the web server 81. Thereafter, the content generating device 70 ends the processing.

In step S630, the communication target data determining unit 663 generates the random number data as associating data for associating the content data and the CD data.

In step S640, the communication target data determining unit 663 determines the CD data as communication target data and generates communication target data including the user ID, the CD data, the random number, and status data indicating “2”. The communication target data determining unit 663 outputs the communication target data to the communication unit 62 and the communication unit 62 transmits the communication target data to the web server 81.

In step S650, the communication target data determining unit 663 stores the content data, the CD data, and the random number data in the storing unit 61 so as to be associated with each other. That is, the communication target data determining unit 663 allocates the random number data to the content data.

In step S660, the communication target data determining unit 663 determines the content data as communication target data and generates communication target data including the user ID, the content data, the random number associated with the content data, and status data indicating “3”. The communication target data determining unit 663 outputs the communication target data to the communication unit 62 and the communication unit 62 transmits the communication target data to the web server 81.

As described above, the user terminal 60 may transmit the CD data to the web server 81 as the communication target data so that the content sharing system 80 may save time and effort to generate CD data. By doing this, the processing load of the content sharing system 80 is reduced. Further, the user terminal 60 determines the communication target data based on the resource of the user terminal 60 and the data which is transmitted from the content generating device 70 to the web server 81. Therefore, the user terminal 60 may satisfactorily and rapidly transmit the communication target data to the web server 81. Further, the user terminal 60 automatically transmits at least one of the content data and the CD data when the content generating device 70 is connected thereto. Therefore, the user terminal 60 may narrow a gap between a date when the content data is generated and a date certified by the time stamp, that is, a date when the time stamp is allocated. Further, the user terminal 60 may remove the personal information data attached to the content data by the setting by the user so that it is possible to prevent the personal information data from being registered in the content sharing system 80 despite user's intentions.

### [Processing by Web Server]

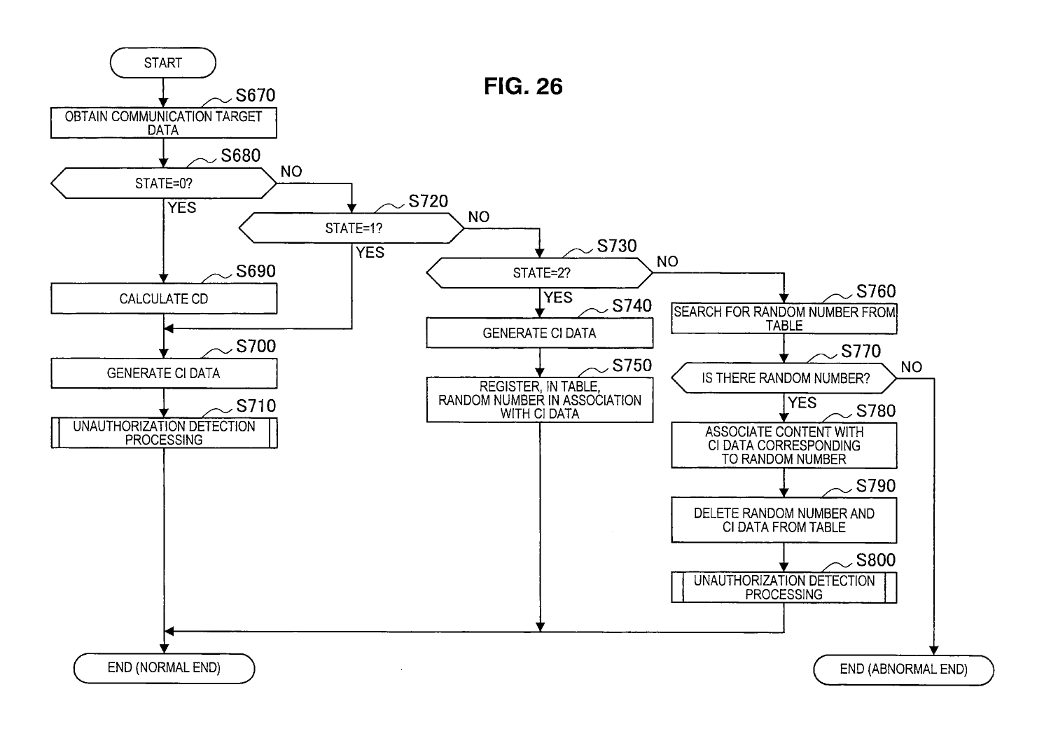

Next, a processing by the web server 81 will be described with reference to FIG. 26. In step S670, the communication unit 811 receives the communication target data and outputs the communication target data to the status determining unit 814. In step S680, the status determining unit 814 determines whether the status data included in the communication target data represents “0”. If it is determined that the status data represents “0”, the status determining unit 814 proceeds to step S690 and if it is determined that the status data represents a number other than “0”, the status determining unit 814 proceeds to step S720.

In step S690, the CD data generating unit 815 inputs the content data included in the communication target data in the hash function to generate the CD data. In step S700, the CI data generating unit 816 obtains the user ID from the communication target data and combines the user ID and the CD data to generate the CI data. Further, if the processing of step 690 is performed, the CD data is calculated in step S690 and if the processing of step S720 is performed, the CD data is included in the communication target data. If the MAC address is included in the communication target data, the CI data generating unit 816 obtains a user ID corresponding to the MAC address from the MAC address related table and combines the user ID and the CD data to generate the CI data. The CI data generating unit 816 associates the content data with the CI data.

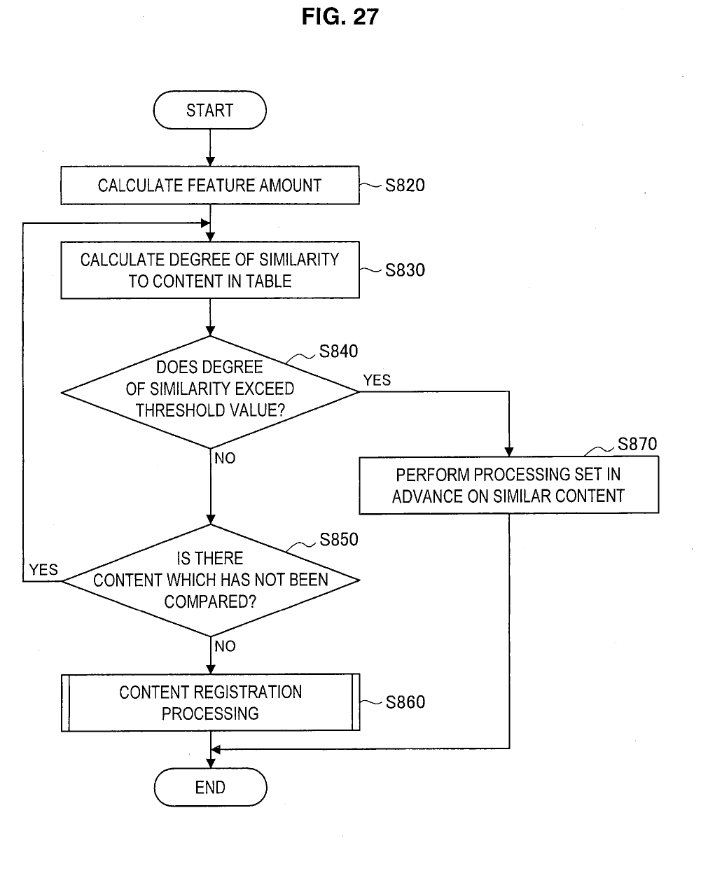

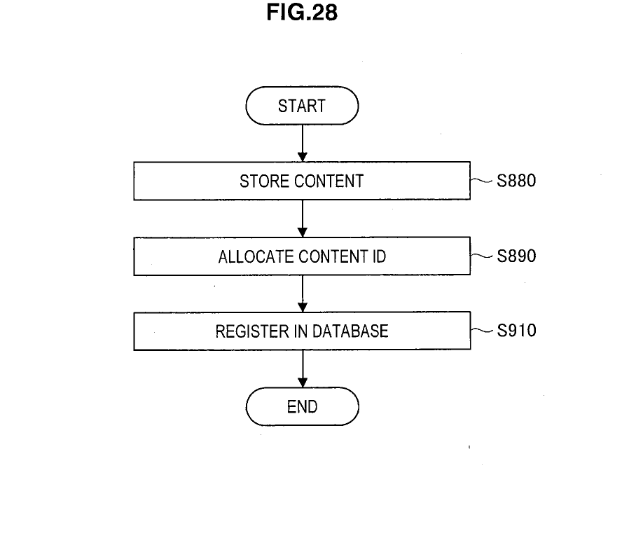

In step S710, the unauthorization determining unit 817 performs the unauthorization detection processing illustrated in FIG. 27. The unauthorization detection processing is schematically a processing that determines whether the content data is proper (whether the content data is similar to the content data owned by another user). Thereafter, the web server 81 ends the processing.

In step S720, the status determining unit 814 determines whether the status data included in the communication target data represents “1”. If it is determined that the status data represents “1”, the status determining unit 814 proceeds to step S700 and if it is determined that the status data represents “2” or “3”, the status determining unit 814 proceeds to step S730.

In step S730, the status determining unit 814 determines whether the status data included in the communication target data represents “2”. If it is determined that the status data represents “2”, the status determining unit 814 proceeds to step S740 and if it is determined that the status data represents “3”, the status determining unit 814 proceeds to step S760.

In step S740, the CI data generating unit 816 obtains the user ID and the CD data from the communication target data and combines the user ID and the CD data to generate the CI data. If the MAC address is included in the communication target data, the CI data generating unit 816 obtains a user ID corresponding to the MAC address from the MAC address related table and combines the user ID and the CD data to generate the CI data.

In step S750, the CI data generating unit 816 registers the random data included in the communication target data and the CI data in the CI data related table so as to be associated with each other. Thereafter, the web server 81 ends the processing.

In step S760, the CI data generating unit 816 searches for the random number data included in the communication target data from the CI data related table. In step S770, the Cl data generating unit 816 determines whether the random number data included in the communication target data is recorded in the CI data related table. If it is determined that the random number data is recorded in the CI data related table, the CI data generating unit 816 proceeds to step S780. If it is determined that the random number data is not recorded in the CI data related table, the CI data generating unit 816 certifies that the random number data is unauthorized and ends the processing.

In step S780, the CI data generating unit 816 obtains the CI data corresponding to the random number data from the CI data associated table and associates the content data included in the communication target data and the CI data. In step S790, the CI data generating unit 816 removes the random number data and the CI data from the CI data related table. In step S800, the unauthorization determining unit 817 performs the unauthorization detection processing illustrated in FIG. 27. Thereafter, the web server 81 ends the processing.

### [Unauthorization Detection Processing]

Next, the unauthorization detection processing which is performed by the unauthorization determining unit 817 will be described with reference to FIG. 27. In step S820, the unauthorization determining unit 817 calculates a feature amount of the content data. Here, the feature amount of the content data is calculated, for example, by an SIFT (scale invariant feature transform) algorithm. The feature amount calculated by the SIFT algorithm has a 128 dimensional vector value and has a feature which is tenacious to the rotation of the content data, the change in a scale, or the illumination change. For example, even though the content data is resized or cut out, the feature amount is hardly changed. Further, a hash value of the content data, that is, a value of the CD data may be significantly changed even though the content data is hardly changed. Therefore, rather than the comparison of the CD data with each other, if the feature amount data are compared with each other, it is possible to precisely determine whether the content data is proper. Further, the SIFT algorithm is disclosed in detail, for example, in “David G. Lowe, “Distinctive image features from scale-invariant keypoints,’ International journal of computer vision, 60, 2 (2004), pp. 91-110”

In step S830, the unauthorization determining unit 817 accesses the database server 83 to obtain a content information management table. Further, the unauthorization determining unit 817 calculates a degree of similarity of the calculated feature amount data, that is, comparison target feature amount data and feature amount data which is stored in any one row of the content information management table, that is, reference feature amount data. Here, the degree of similarity indicates a degree that the feature amount data are approximate to each other. The unauthorization determining unit 817, for example, calculates a differential value of the comparison target feature amount data and the reference feature amount data for every dimension and assumes a value corresponding to an arithmetic average value of the differential values as the degree of similarity. In this case, the degree of similarity is decreased as the arithmetic average value is increased.

The unauthorization determining unit 817 determines whether the degree of similarity exceeds a predetermined threshold value. If it is determined that the degree of similarity exceeds the threshold value, the unauthorization determining unit 817 proceeds to step S870 and if it is determined that the degree of similarity is equal to or smaller than the threshold value, the unauthorization determining unit 817 proceeds to step S850.

In step S850, the unauthorization determining unit 817 determines whether there is reference feature amount data which is not compared with the comparison target feature amount data. If it is determined that there is the reference feature amount which is not compared with the comparison target feature amount data, the unauthorization determining unit 817 returns to step S830 and if it is determined that all reference feature amount data is compared with the comparison target feature amount data, the unauthorization determining unit 817 proceeds to step S860.

In step S860, the user request processing unit 813 registers the content data transmitted from the user in the content information management table. Specifically, the user request processing unit 813 performs a content registration processing illustrated in FIG. 28.

In step S870, the unauthorization determining unit 817 performs an unauthorization processing set in advance among unauthorization processings registered in the wrongful processing determining table. Such a setting may be arbitrarily performed by the web server 81 or by a user (proper user) who posts proper content data. Further, the notification to the proper user is performed by, for example, transmitting data indicating that unauthorized content data is received (for example, image data or audio data) to the user terminal 60 of the proper user. Further, if the posting is not rejected, the same processing as step S860 is performed. Thereafter, the unauthorization determining unit 817 ends the unauthorization detection processing.

The web server 81 performs the unauthorization detection processing to satisfactorily prevent unauthorized posting by a user. As the unauthorized posting, for example, the following examples may be considered. That is, a user 40b used, without authorization, the content data which is properly posted by a user 40a in a location different from the content sharing system 80. Further, a user 40c tried to post the content data in the content sharing system 80. In this case, the above-mentioned wrongful processing is performed. By doing this, the unauthorized posting by the user 40c may be excluded.

### [Content Registration Processing]

Next, a content registration processing will be described with reference to FIG. 28. In step S880, the user request processing unit 813 transmits the content data included in the communication target data to the storage server 82 and the control unit 822 of the storage server 82 stores the content data in the storing unit 820. The control unit 822 transmits the content path data indicating the location of the content data to the web server 81.

In step S890, the user request processing unit 813 allocates a content ID to the content data. Further, the user request processing unit 813 generates the reception date data indicating a date when the content data is received (specifically, a date when the communication target date including the content data is received). In step S910, the user request processing unit 813 transmits the content ID, the user ID, the content path data, the CD data, the feature amount data, and the reception date data to the database server 83 so as to be associated with each other. The control unit 832 of the database server 83 records these data in the content information management table so as to be associated with each other. At this time, the time stamp ID has an initial value (for example, “0”).

### [Processing by Time Stamp Obtaining Engine]

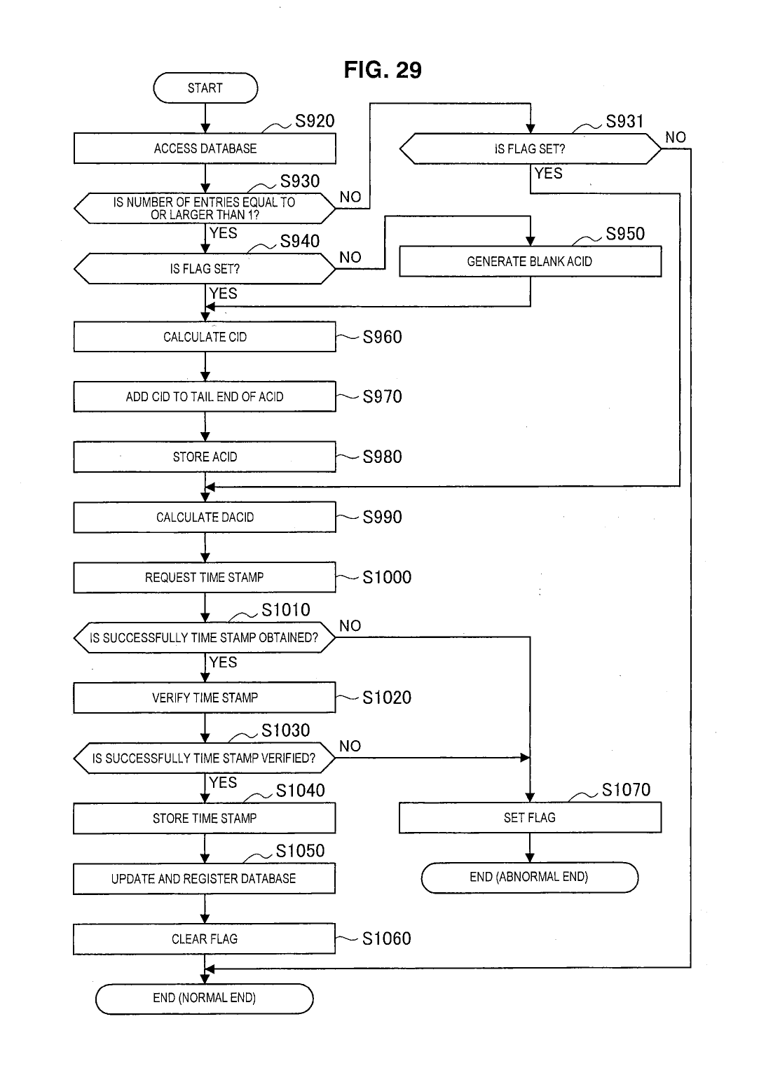

Next, a processing by the time stamp obtaining engine 84 will be described with reference to FIG. 29. The time stamp obtaining engine 84 performs a processing by FIG. 29 at regular time intervals. Further, the time stamp obtaining engine 84 performs the processing regardless of the processing by other servers which configure the content sharing system 80 or a request by the user.

In step S920, the CID data generating unit 843 accesses the content information management table in the database server 83. In step S930, the CID data generating unit 843 determines whether there are one or more rows (entries) in which the time stamp ID is “0”, in the content information management table. If it is determined that there are one or more entries in which the time stamp ID is “0”, the CID data generating unit 843 proceeds to step S940 and if it is determined that there is no entry in which the time stamp ID is “0”, the CID data generating unit 843 proceeds to step S931. The CID data generating unit 843 performs the following processing based on the entry in which the time stamp ID is “0”.

In step S931, the CID data generating unit 843 determines whether the time stamp flag is set. If it is determined that the time stamp flag stands, the CID data generating unit 843 refers to the ACID path data (the ACID path data is given in step S980 which will be described below) to obtain the ACID data from the storage server 82. Thereafter, the CID data generating unit 843 proceeds to step S990. In contrast, if it is determined that the time stamp flag is cleared, the CID data generating unit 843 ends the processing.

In step S940, the CID data generating unit 843 determines whether the time stamp flag stands. If it is determined that the time stamp flag stands, the CID data generating unit 843 proceeds to step S960 and if it is determined that the time stamp flag is cleared, the CID data generating unit 843 proceeds to step S950.

In step S950, the ACID data generating unit 844 generates blank ACID data. In step S960, the CID data generating unit 843 combines the user ID in the entry with the CD data to generate the CI data and inputs the CI data in the hash function to generate the CID data.

In step S970, the ACID data generating unit 844 adds the CID data at a tail end of the ACID data. In step S980, the ACID data generating unit 844 transmits the ACID data to the storage server 82. The control unit 822 of the storage server 82 stores the ACID data in the storing unit 820. The control unit 822 transmits the ACID path data indicating the location of the ACID data to the time stamp obtaining engine 84. The ACID data generating unit 844 stores the ACID path data in the storing unit 840.

In step S990, the request data generating unit 845 inputs the ACID data in the hash function to generate DACID data. In step S1000, the request data generating unit 845 transmits the time stamp request data which requests the time stamp and the DACID data to the time stamp allocating server 20. In response to this, the time stamp allocating server 20 generates time stamp tag data and transmits the time stamp tag data to the time stamp obtaining engine 84.

In step S1010, the request data generating unit 845 determines whether the time stamp tag data is received. If it is determined that the time stamp tag data is obtained, the request data generating unit 845 proceeds to step S1020 and if it is determined that the time stamp tag data is not received, the request data generating unit 845 proceeds to step S1070.

In step S1020, the request data generating unit 845 verifies the time stamp tag data. Specifically, the request data generating unit 845 determines whether the signature data in the time stamp tag data is proper, based on a public key of the time stamp authority 30 which is obtained from the time stamp authority 30 in advance. If it is determined that the signature data in the time stamp tag data is proper, the request data generating unit 845 determines that the time stamp tag data is successfully verified.

In step S1030, the request data generating unit 845 determines whether the time stamp tag data is successfully verified. If it is determined that the time stamp tag data is successfully verified, the request data generating unit 845 proceeds to step S1040 and if it is determined that the verification of the time stamp tag data is failed, the request data generating unit 845 proceeds to step S1070.

In step S1040, the request data generating unit 845 transmits the time stamp tag data to the storage server 82. The control unit 822 of the storage server 82 stores the time stamp tag data in the storing unit 820. The control unit 822 transmits the time stamp path data indicating the location of the time stamp tag data to the time stamp obtaining engine 84. The request data generating unit 845 stores the time stamp path data in the storing unit 840.

The request data generating unit 845 allocates the time stamp ID to the time stamp tag data. Further, the request data generating unit 845 obtains the time stamp date data from the time stamp tag data. The request data generating unit 845 transmits the time stamp ID, the time stamp path data, the ACID path data, the DACID data, and the time stamp date data to the database server 83 so as to be associated with each other. The control unit 832 of the database server 83 stores these data in the time stamp information management table so as to be associated with each other.

In step S1060, the request data generating unit 845 clears the time stamp flag. Thereafter, the time stamp obtaining engine 84 ends the processing. In step S1070, the request data generating unit 845 sets the time stamp flag. Thereafter, the time stamp obtaining engine 84 ends the processing.

As described above, the time stamp obtaining engine 84 may perform the processing independently from other servers which configure the content sharing system 80. By doing this, the time stamp obtaining engine 84 may reduce variation in the time stamp obtaining date even though the resource of the content sharing system 80 is varied.

Further, the time stamp obtaining engine 84 performs the generation of the ACID data and the time stamp request in separate steps so that even though the obtaining or verification of the time stamp is failed, the ACID data does not need to be re-generated.

[Processing when Content Data is Removed or Withdrawn]

When a user makes a request for removal of the content data or withdrawal from a service provided by the content sharing system 80, the web server 81 performs the following processing. That is, if the request is received, the user request processing unit 813 removes the content data from the storage server 82. The user request processing unit 813 retains other data, for example, the data in the content information management table and the time stamp information management table as it is. By doing this, even after the removal of the content or the withdrawal, the user may obtain time stamp tag data. Specifically, the user terminal 60 transmits the user ID and the content data to the web server 81. The CD data generating unit 815 of the web server 81 inputs the content data in the hash function to generate CD data. Next, the user request processing unit 813 searches for a row corresponding to the user ID and the CD data from the content information management table. Next, the user request processing unit 813 obtains the time stamp ID from the searched row and searches for the row corresponding to the time stamp ID from the time stamp information management table. Next, the user request processing unit 813 obtains the time stamp path data from the searched row and obtains the time stamp tag data from the storage server 82 based on the time stamp path data. Next, the user request processing unit 813 transmits the time stamp tag data to the user terminal 60. By doing this, the user may obtain the time stamp tag data.

### [Publishing of Content Data]

Next, publishing of content data will be described. Even though the content data is published in the same manner as the first embodiment, contents of the CP data are different. Specifically, first of all, the user terminal 60 transmits the content ID which is designated by the user to the web server 81. By doing this, the user makes a request for browsing of the content data.

When there is a request for browsing the content data from the user, the user request processing unit 813 searches for the row corresponding to the content ID from the content information management table. The user request processing unit 813 obtains the user ID, the content path data, and the time stamp ID from the searched row. Next, the user request processing unit 813 obtains the content data from the storage server 82 based on the content path data. Further, the user request processing unit 813 searches for the row corresponding to the time stamp ID from the time stamp information management table and obtains the ACID path data and the time stamp path data from the searched row. The user request processing unit 813 obtains the ACID data and the time stamp tag data from the storage server 82 based on the path data.

The user request processing unit 813 makes a package of the obtained user ID, content data, ACID data, and time stamp tag data to generate the CP data. Therefore, the CP data of the second embodiment is simpler than the CP data of the first embodiment (see FIG. 8). Further, as a method of making a package of the data, for example, a method of archiving the data as a zip file is considered (same as in the first embodiment).

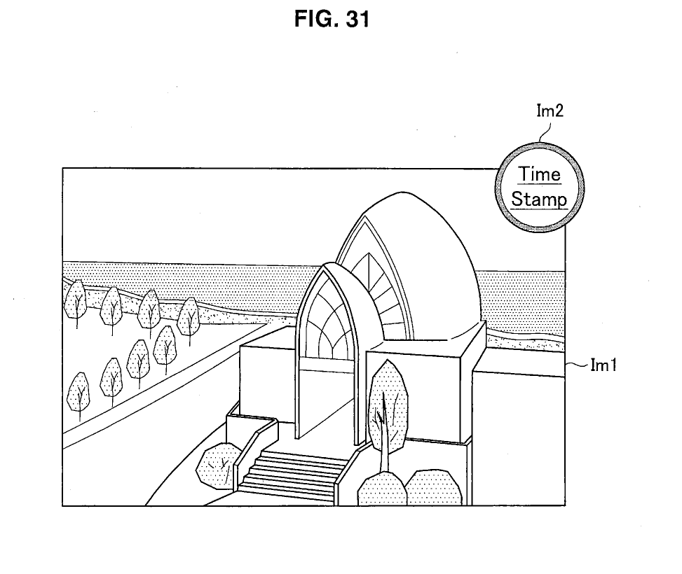

Next, the user request processing unit 813 transmits the CP data to the user terminal 60. The control unit 66 of the user terminal 60 displays the content data on the display unit 65 based on the CP data. A display example is illustrated in FIG. 31. The display unit 65 displays an icon Im2 indicating that the time stamp is allocated to the content data Im1 near the content data Im1. By doing this, the content sharing system 80 may give a strong impression that the time stamp is allocated to the content data Im1 to the user.

### [Verification Processing]

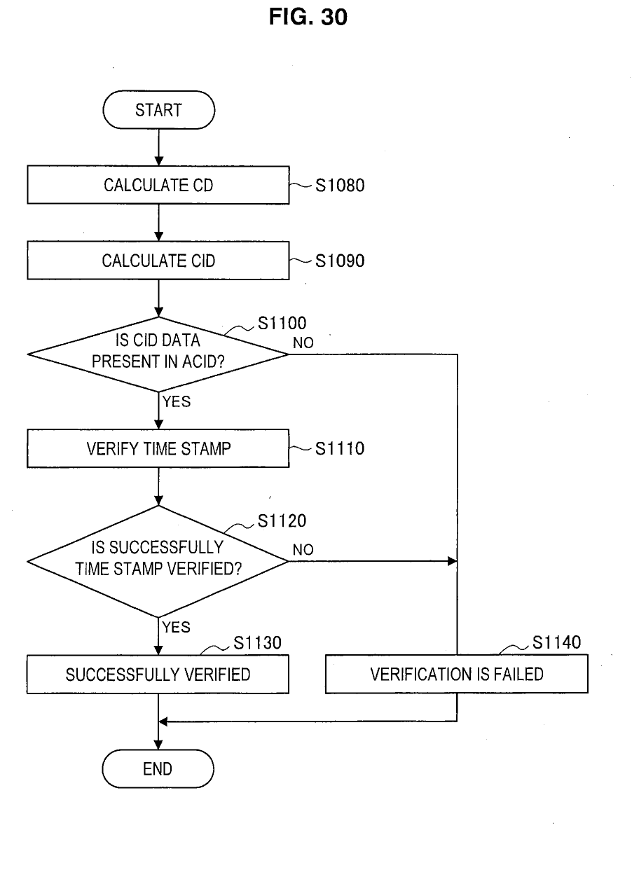

Next, a verification processing will be described with reference to FIG. 30. In the second embodiment, each user terminal 60 performs the verification processing on the CP data. It is obvious that a verifying server for verification may be separately prepared and the following verification processing may be performed in the verifying server. Further, any one of user terminals 60 may be used as a terminal for verification. The verification processing starts, for example, by the request from the user. In the verification processing of the second embodiment, the CP data is transmitted to the user terminal 60 or the verifying server and the user terminal 60 or the verifying server performs the verification processing on the CP data, which is different from the verification processing of the first embodiment.

In step S1080, the verifying unit 664 illustrated in FIG. 15 inputs the content data in the CP data in the hash function to generate CD data for verification. In step S1090, the verifying unit 664 combines the user ID in the CP data with the CD data for verification to generate CID data for verification. In step S1100, the verifying unit 664 determines whether the CID data for verification is present in the ACID data in the CP data. If it is determined that the CID data for verification is present in the ACID data in the CP data, the verifying unit 664 proceeds to step S1110 and if it is determined that the CID data for verification is not present in the ACID data in the CP data, the verifying unit 664 proceeds to step S1140.

In step S1110, the verifying unit 664 verifies the time stamp tag data in the CP data. Specifically, the verifying unit 664 determines whether the signature data in the time stamp tag data is proper, based on the public key of the time stamp authority 30. The verifying unit 664 may obtain the public key from the time stamp authority 30 in advance or obtain the public key from the time stamp authority 30 in step of performing the processing in step S1110. If it is determined that the signature data is proper, the verifying unit 664 determines that the time stamp tag data is successfully verified.

In step S1120, the verifying unit 664 determines whether the time stamp tag data is successfully verified. If it is determined that the time stamp is successfully verified, the verifying unit 664 proceeds to step S1130 and if it is determined that the verification of the time stamp is failed, the verifying unit 664 proceeds to step S1140.

In step S1130, the verifying unit 664 determines that the CP data is successfully verified. Further, the verifying unit 664 displays information indicating that the verification is successful, the user ID in the CP data, and the time stamp date data in the CP data on the display unit 65. The verifying unit 664 may output these data as audio. Thereafter, the verifying unit 664 ends the verification processing. In the meantime, in step S1140, the verifying unit 664 determines that the verification of the CP data is failed. Further, the verifying unit 664 displays information indicating that the verification is failed on the display unit 65. In addition, when the verifying server performs the verification processing, the verifying server transmits information indicating that the verification is successful (or failed) to the user terminal 60 which issues the request. As described above, in the second embodiment, the user terminal 60 or the verifying server performs the verification processing on the CP data so that if the content sharing system 80 is suspended, the verification processing may be performed.

As described above, in the second embodiment, the user terminal 60 or the content generating device 70 transmits the CD data to the content sharing system 80 so that the content sharing system 80 may save time and effort to generate the CD data.

Further, the content generating device 70 transmits at least one of the content data and the CD data as the communication target data at the time of generating the content data so that a gap between a date when the content data is generated and a date certified by the time stamp may be narrowed.

Further, the content generating device 70 determines the communication target data based on the communication band with the content sharing system 80 so that the communication target data is rapidly and reliably transmitted to the content sharing system 80. For example, when the communication band is narrow, if a large quantity of communication target data is transmitted to the content sharing system 80, the communication speed may be considerably lowered or the communication target data may be defective. However, the content generating device 70 determines the communication target data based on the communication band so that it is possible to reliably avoid the significant lowering of the communication speed or the defect of the communication target data.

Further, if the CD data is the communication target data, the content generating device 70 transmits the CD data to the content sharing system 80 and then determines whether the content data is transmitted as the communication target data based on the communication band. Therefore, the content generating device 70 transmits the CD data to the content sharing system 80 and then reliably transmits the content data.

Further, when the CD data and the content data are transmitted as separate communication target data, the content generating device 70 includes the random number data for associating these data in the communication target data. Therefore, the content sharing system 80 may easily associate the CD data and the content data.

Further, the content generating device 70 includes the content of the communication target data, that is, the status data regarding the communication status in the communication target data so that the content sharing system 80 may easily determine the communication status at the current time.

Further, when the content generating device 70 is connected, the user terminal 60 obtains the content data from the content generating device 70. In addition, if the content generating device 70 does not generate the CD data, the user terminal 60 transmits the CD data to the content sharing system 80. Therefore, the user terminal 60 may prevent the CD data from being repeatedly transmitted to the content sharing system 80. Further, the user terminal 60 transmits at least one of the content data and the CD data as the communication target data when the content generating device 70 is connected thereto so that a gap between a date when the content data is generated and a date certified by the time stamp may be narrowed.

Further, the user terminal 60 determines the communication target data based on the data transmitted from the content generating device 70 to the content sharing system 80 so that the data is prevented from being repeatedly transmitted to the content sharing system 80.

Further, if the content generating device 70 transmits the CD data and the random number data to the content sharing system 80, the user terminal 60 determines the content data and the random number data as the communication target data. Therefore, the user terminal 60 may prevent the data from being repeatedly transmitted to the content sharing system 80. Further, the content sharing system 80 may easily associate the CD data and the content data.

Further, the user terminal 60 includes the content of the communication target data, that is, the status data regarding the communication status in the communication target data so that the content sharing system 80 easily determine the communication status at the current time.

Further, the time stamp obtaining engine 84 performs the processing independently from other servers so that even when the resource is changed, the variation in the time stamp obtaining time may be reduced.

Further, the time stamp obtaining engine 84 performs the generation of the ACID data and the time stamp request in separate steps so that even though the obtaining or verification of the time stamp is failed, the ACID data does not need to be re-generated.

Further, the content data, the time stamp tag data, and the ACID data are stored in a storage server 82 which is different from the database server 83 which stores information for managing these data (management tables illustrated in FIGS. 20 and 21). Therefore, an accessing load applied to the storage server 82 is reduced.

Further, the management tables are stored in the database server 83 so that the storage server 82 may be easily distributed.

Further, the user terminal 60 or the verifying server performs the verification processing on the CP data so that even though the content sharing system 80 is suspended, the verification processing may be performed.

Further, the time stamp ID is recorded in the content information management table so that the content sharing system 80 efficiently searches for the time stamp tag data. In addition, the data which configures the CP data is stored in the management table and the storage server 82 so that the content data sharing system does not need to store the CP data in the storage server 82.

As described above, even though preferred embodiments of the present disclosure have been described in detail with reference to the accompanying drawings, the present disclosure is not limited to the embodiments. It is obvious to those skilled in the art that various modified examples and changed examples may be made within the technical spirit as set out in the claims and it is also understood that the modified examples and the changed examples are included in the technical scope of the present disclosure.

For example, in the first embodiment, the content sharing server 10 and the time stamp allocating server 20 are separately provided but the content sharing server 10 may have a function of the time stamp allocating server 20. In contrast, the time stamp allocating server 20 may have a function of the content sharing server 10.

Further, even though the verification processing is performed in accordance with the request from the request data generating unit 135 in the first embodiment, the verification processing may be performed in accordance with the request from the user 41. That is, a user who downloads the CP data including the contents and the time stamp wants to check the validity of the time stamp, the user may transmit the CP data to a separate verifying server which has only a function of the content sharing server 10 or the verifying unit 14 and makes a request for the inspection of the validity of the time stamp. In this case, the content sharing server 10 or the verifying server which receives the request performs the determination on the CP data which is requested by the user by performing the same processing as the processing illustrated in FIG. 12.

Further, the verifying unit 14, that is, the content sharing server 10 or the verifying server performs the verification processing, but the user terminal 40 may perform the verification processing. In this case, functions required for the verification are published in advance. In addition, when the user terminal 40 receives the CP data, the user terminal 40 determines whether the CP data is correct by the same processing as the processing illustrated in FIG. 12.

Further, the content sharing server 10 outputs all content data which is uploaded by the generator to the generator of the content data but may output only content data to which the time stamp tag data is allocated. By doing this, the processing load of the content sharing server 10 may be reduced.

Further, the content sharing server 10 outputs the content data to which the time stamp is allocated to the user terminal 40 of the third party but may output all content data to a user terminal 40 of a user 41 which has browsing permission from the generator of the content data.

Further, a plurality of content data management tables may be provided. For example, the content sharing server 10 may prepare the content data management table for every user 41. The content data management table is not the data itself but may record a link to a data which is stored in the storing unit 12.

Further, in the first embodiment, the user terminal 40 and the content sharing server 10 are connected to each other through the network 50, but may be connected by a home network or directly connected.

Further, the configuration of the first embodiment and the configuration of the second embodiment may be arbitrarily combined. For example, the user terminal 40 of the first embodiment may be replaced with the user terminal 60 or the content generating device 70 of the second embodiment. In this case, the content sharing server 10 may perform the same processing as the content sharing system 80 so that, for example, the CD data does not need to be generated.

Further, a processing that deletes the personal information data, which is performed in the second embodiment may be performed by each of the user terminals 40 of the first embodiment.

Further, the unauthorization detection processing performed in the second embodiment may be performed by the content sharing server 10 of the first embodiment.

Further, the content sharing server 10 of the first embodiment may be replaced with the content sharing system 80 of the second embodiment. In this case, the content data is transmitted from the user terminal 40 so that the content sharing system 80 may perform the processings of steps S690 to S710 in the processing illustrated in FIG. 26.

Additionally, the present technology may also be configured as below.

(1)

An information processing apparatus including:

a time stamp request unit which requests a time stamp for content data output from a user device from a time stamp allocating unit; and

a content data output unit which outputs the content data to which the time stamp is allocated to another user device other than the user device which outputs the content data.

(2)

The information processing apparatus according to (1), wherein the time stamp request unit requests a time stamp for data in which a plurality of pieces of the content data are aggregated from the time stamp allocating unit.

(3)

The information processing apparatus according to (1) or (2), wherein the time stamp request unit requests, from the time stamp allocating unit, a time stamp for content data output from the user device and identification data indicating a user of the user device which outputs the content data.

(4)

The information processing apparatus according to any one of (1) to (3), wherein the content data output unit outputs the content data to which the time stamp is not allocated in addition to the content data to which the time stamp is allocated to a device a user who outputs the content data owns.

(5)

The information processing apparatus according to any one of (1) to (4), wherein, when the time stamp is allocated from the time stamp allocating unit after requesting the time stamp from the time stamp allocating unit, the time stamp request unit requests a new time stamp from the time stamp allocating unit.

(6)

The information processing apparatus according to any one of (1) to (4), wherein the time stamp request unit requests the time stamp from the time stamp allocating unit each time the content data is output from the user device.

(7)

The information processing apparatus according to any one of (1) to (6), wherein the content data output unit further outputs the time stamp which is allocated to the content data to the other user device.

(8)

The information processing apparatus according to (7), wherein, when the time stamp is requested by the other user device, the content data output unit outputs the time stamp which is allocated to the content data to the other user device.

(9)

The information processing apparatus according to any one of (1) to (4), wherein, when the user device which outputs the content data requests allocation of the time stamp, the time stamp request unit requests the time stamp from the time stamp allocating unit.

(10)

An information processing method including:

requesting, from a time stamp allocating unit, a time stamp for content data output from any one of a plurality of user devices; and

outputting the content data to another user device other than the user device which outputs the content data, among the plurality of user devices when the time stamp is allocated to the content data.

(11)

A program for causing a computer to implement:

a time stamp request function of requesting, from a time stamp allocating unit, a time stamp for content data output from any one of a plurality of user devices; and

a content data output function of outputting the content data to another user device other than the user data which outputs the content data, among the plurality of user devices when the time stamp is allocated to the content data.

(12)

An information processing system including a plurality of user devices and an information processing apparatus,

wherein the information processing apparatus includes:

a time stamp request unit which requests a time stamp for content data output from any one of the plurality of user devices from a time stamp allocating unit; and

a content data output unit which outputs the content data to which the time stamp is allocated to other user devices than the user device which outputs the content data.

(13)

The information processing system according to (12), further including a verifying device which verifies whether the time stamp which is allocated to the content data is correct in accordance with a request from a user of the user device.

(14)

The information processing system according to (12) or (13), wherein the user device includes a verifying unit which verifies whether the time stamp which is allocated to the content data is correct.

(15)

An information processing apparatus including:

a content obtaining unit which obtains content data;

a content digest data generating unit which generates content digest data; and

a communication unit which transmits the content digest data to another information processing apparatus.

(16)

The information processing apparatus according to (15), further including:

a communication target data determining unit which determines at least one of the content data and the content digest data as the communication target data based on a communication band between the communication unit and the other information processing apparatus,

wherein the communication unit transmits the communication target data to the other information processing apparatus.

(17)

The information processing apparatus according to (16), wherein the communication target data determining unit determines at least one of the content data and the content digest data as first communication target data based on the communication band, and determines whether the content data is considered as second communication target data based on the communication band after the communication unit transmits the content digest data to the other information processing apparatus if the content digest data is determined as the first communication target data.

(18)

The information processing apparatus according to (17), wherein, when the content digest data is considered as the first communication target data, the communication target data determining unit includes associating data for associating the content data and the content digest data in the first communication target data.

(19)

The information processing apparatus according to (18), wherein, when the content data is considered as the second communication target data, the communication target data determining unit includes the associating data in the second communication target data.

(20)

The information processing apparatus according to any one of (16) to (19), wherein the communication target data determining unit allocates status data regarding contents of the communication target data to the communication target data.

(21)

The information processing apparatus according to (15), further including a connection detecting unit which detects the connection of a content generating device which generates the content data,

wherein the content obtaining unit obtains the content data from the content generating device when the connection detecting unit detects the connection of the content generating device, and

the content digest data generating unit generates the content digest data when the content generating device does not generate the content digest data.

(22)

The information processing apparatus according to (21), further including a communication target data determining unit which determines at least one of the content data and the content digest data as the communication target data based on the data which is transmitted from the content generating device to the other information processing apparatus,

wherein the communication unit transmits the communication target data to the other information processing apparatus.

(23)

The information processing apparatus according to (22), wherein the content generating device transmits the content digest data and associating data which associates the content data and the content digest data to the other information processing apparatus, and

when the content generating device transmits the content digest data and the associating data to the other information processing apparatus, the communication target data determining unit determines the content data and the associating data as the communication target data.

(24)

The information processing apparatus according to (22) or (23), wherein the communication target data determining unit allocates status data regarding contents of the communication target data to the communication target data.

(25)

An information processing method including:

obtaining content data;

generating content digest data; and

transmitting the content digest data to another information processing apparatus.

(26)

A program for causing a computer to implement:

a content obtaining function of obtaining content data;

a content digest data generating function of generating content digest data; and

a communication function of transmitting the content digest data to another information processing apparatus.

(27)

An information processing system, including a first information processing apparatus which receives content data output from a user device;

a second information processing apparatus which requests a time stamp for the content data from a time stamp allocating unit;

a third information processing apparatus which stores the content data and a time stamp which is allocated to the content data; and

a fourth information processing apparatus which stores content identification data for identifying the content data, content path data which indicates a location of the content data in the third information processing apparatus, and time stamp path data which indicates a location of the time stamp in the third information processing apparatus so as to be associated with each other.

### REFERENCE SIGNS LIST

10 Content sharing server
20 Time stamp allocating server
30 Time stamp authority
40 User terminal
41 User
50 Network
12 Storing unit
13 Data generating unit
14 Verifying unit
100 Information processing system
131 Content digest data generating unit
132 Content information data generating unit
133 Content information digest data generating unit
134 Aggregated content information digest data generating unit
135 Request data generating unit
136 Content package data generating unit
200 Information processing system
60 User terminal
70 Content generating device
80 Content sharing system
63 Connection detecting unit
661, 761 Content obtaining unit
662, 762 Content digest data generating unit
663, 763 Communication target data determining unit
664 Verifying unit
81 Web server
82 Storage server
83 Database server
84 Time stamp obtaining engine

1. An information processing apparatus comprising:
a time stamp request unit which requests a time stamp for content data output from a user device from a time stamp allocating unit; and
a content data output unit which outputs the content data to which the time stamp is allocated to another user device other than the user device which outputs the content data.

2. The information processing apparatus according to claim 1, wherein the time stamp request unit requests a time stamp for data in which a plurality of pieces of the content data are aggregated from the time stamp allocating unit.

3. The information processing apparatus according to claim 1, wherein the time stamp request unit requests, from the time stamp allocating unit, a time stamp for content data output from the user device and identification data indicating a user of the user device which outputs the content data.

4. The information processing apparatus according to claim 1, wherein the content data output unit outputs the content data to which the time stamp is not allocated in addition to the content data to which the time stamp is allocated to a device a user who outputs the content data owns.

5. The information processing apparatus according to claim 1, wherein, when the time stamp is allocated from the time stamp allocating unit after requesting the time stamp from the time stamp allocating unit, the time stamp request unit requests a new time stamp from the time stamp allocating unit.

6. The information processing apparatus according to claim 1, wherein the time stamp request unit requests the time stamp from the time stamp allocating unit each time the content data is output from the user device.

7. The information processing apparatus according to claim 1, wherein the content data output unit further outputs the time stamp which is allocated to the content data to the other user device.

8. The information processing apparatus according to claim 7, wherein, when the time stamp is requested by the other user device, the content data output unit outputs the time stamp which is allocated to the content data to the other user device.

9. The information processing apparatus according to claim 1, wherein, when the user device which outputs the content data requests allocation of the time stamp, the time stamp request unit requests the time stamp from the time stamp allocating unit.

10. An information processing method comprising:
requesting, from a time stamp allocating unit, a time stamp for content data output from any one of a plurality of user devices; and
outputting the content data to another user device other than the user device which outputs the content data, among the plurality of user devices when the time stamp is allocated to the content data.

11. A program for causing a computer to implement:
a time stamp request function of requesting, from a time stamp allocating unit, a time stamp for content data output from any one of a plurality of user devices; and
a content data output function of outputting the content data to another user device other than the user data which outputs the content data, among the plurality of user devices when the time stamp is allocated to the content data.

12. An information processing apparatus comprising:
a content obtaining unit which obtains content data;
a content digest data generating unit which generates content digest data; and
a communication unit which transmits the content digest data to another information processing apparatus.

13. The information processing apparatus according to claim 12, further comprising:
a communication target data determining unit which determines at least one of the content data and the content digest data as the communication target data based on a communication band between the communication unit and the other information processing apparatus,
wherein the communication unit transmits the communication target data to the other information processing apparatus.

14. The information processing apparatus according to claim 13, wherein the communication target data determining unit determines at least one of the content data and the content digest data as first communication target data based on the communication band, and determines whether the content data is considered as second communication target data based on the communication band after the communication unit transmits the content digest data to the other information processing apparatus if the content digest data is determined as the first communication target data.

15. The information processing apparatus according to claim 14, wherein, when the content digest data is considered as the first communication target data, the communication target data determining unit includes associating data for associating the content data and the content digest data in the first communication target data.

16. The information processing apparatus according to claim 15, wherein, when the content data is considered as the second communication target data, the communication target data determining unit includes the associating data in the second communication target data.

17. The information processing apparatus according to claim 13, wherein the communication target data determining unit allocates status data regarding a content of the communication target data to the communication target data.

18. An information processing method comprising:
obtaining content data;
generating content digest data; and
transmitting the content digest data to another information processing apparatus.

19. A program for causing a computer to implement:
a content obtaining function of obtaining content data;
a content digest data generating function of generating content digest data; and
a communication function of transmitting the content digest data to another information processing apparatus.
